(19) United States
(12) Patent Application Publication
(10) Pub. No.: US 2026/0146584 A1
(43) Pub. Date: May 28, 2026

(54) IMPROVEMENTS IN AND RELATING TO ASSEMBLING A STRUCTURE

(71) Applicant: Planet 42B Limited, Aberdeen (GB)

(72) Inventors: Charles John Whyte, Aberdeen (GB); Alan William Heny West, Aberdeen (GB); John Stephen Giles, Aberdeen (GB)

(21) Appl. No.: 18/878,809

(22) PCT Filed: Jun. 30, 2023
(86) PCT No.: PCT/GB2023/051728

§ 371 Date: Dec. 24, 2024

(30) Foreign Application Priority Data
Jul. 10, 2022 (GB) 2209710.9
Sep. 27, 2022 (GB) 2214097.4
Mar. 3, 2023 (GB) 2303196.6
Apr. 3, 2023 (WO) PCT/GB2023/050885
Jun. 1, 2023 (GB) 2308222.5

(51) Int. Cl. F03D 13/10; F03D 13/20; F03D 13/25; F03D 13/40

(52) U.S. Cl. CPC F03D 13/126; F03D 13/104; F03D 13/112; F03D 13/116; F03D 13/139; F03D 13/203; F03D 13/256; F03D 13/402; F05B 2230/61; F05B 2240/912; F05B 2240/93; F05B 2240/95

(57) ABSTRACT

A method of assembling an offshore wind turbine, such as a floating offshore wind turbine, is disclosed. The method comprises the steps of: transporting, on one or more vessels, a nacelle and a tower of the offshore wind turbine to an assembly area below a support apparatus; suspending the tower and the nacelle from the support apparatus; transporting a floating/buoyant base or foundation body to the assembly area below the support apparatus; and landing the tower on the floating/buoyant base or foundation body and the nacelle on the tower. Also disclosed is a support apparatus for assembling an offshore wind turbine, such as a floating offshore wind turbine.

### FIELD OF INVENTION

The present invention relates to a device/apparatus and/or a system for assembling a structure, such as an (offshore) structure or (offshore) wind turbine or (offshore) jacket. The present invention also relates to a method of deploying a device/apparatus or system for assembling an (offshore) structure, such as an offshore structure, or (offshore) wind turbine or (offshore) jacket. The present invention also relates to a method of assembling a structure or (offshore) turbine(s) or jacket, such as a wind turbine(s) or jacket, e.g., an offshore wind turbine(s) or offshore jacket. The structure is beneficially a floating/buoyant structure and/or is provided on a floating/buoyant body.

In particular, though not exclusively, the invention relates to a method of assembling, e.g., at an offshore location, a wind turbine structure or jacket, e.g., intended for offshore use, and to apparatus for assembling a wind turbine or jacket.

### BACKGROUND TO INVENTION

In the field of wind turbines, in particular offshore wind turbines, there is a general trend towards installing increasingly high power-output wind turbines, for example, turbine capable of outputting 10 Mega Watts or more. However, along with increased power capabilities, the physical dimensions of such wind turbines are also increasing.

Historically, wind turbines, or at least assembled or semi-assembled components of wind turbines, may have been manufactured and/or assembled at a first location, then transported by road to a further location for deployment and/or further assembly. However, due to their increased physical dimensions, transport by road of modern turbines, or assembled portions of modern turbines, is no longer practically possible.

At present, wind turbines and their associated structures may be separately constructed onshore and transported in sections to an offshore site. There, such may be moved into position and fixed using slings and cranes.

This background serves to set a scene to allow a skilled reader to better appreciate the following description. Therefore, none of the above discussion should necessarily be taken as an acknowledgement that that discussion is part of the state of the art or is common general knowledge.

Further background material includes GB 2479232 B (W3G SHIPPING LTD), which describes structures, such as wind turbine structures for offshore sites, comprising transport elements, e.g., an annular protrusion configured for complementary mating with engagement portions of a clamp, which allow for transporting of the structures using that clamp. The clamp may comprise two or more portions, which are positioned around the structure. A wind turbine may be transported as a completed structure. Generally, the transport element is provided at an attachment region of a tower, or the like, where the tower would attach to a support, such as a jacket. There is also described apparatus for allowing for transport of a wind turbine structure, comprising a clamp. In some cases, the apparatus is also configured so as to modify the effective centre of gravity of an associated structure, and/or the effective centre of inertia of an associated structure. An orientation assembly comprising six actuators controlled by the use of positioning signals may be provided to allow relative movement of the clamp, and thus the clamped structure, with respect to a lifting device. A crane may transport a wind turbine to/from a barge.

GB 2479232 B (W3G SHIPPING LTD) discloses a system, such as an offshore system, the system comprising: a wind turbine structure for a site, such as an offshore site. The structure comprises a tower for supporting a turbine and a transport element, the transport element being provided at a base of the tower and being part of a complementary mating arrangement, wherein the transport element is mateable with an engagement element of a clamp; and an apparatus for allowing for transport of the structure, the apparatus comprising the clamp having the engagement element, the engagement element being another part of the complementary mating arrangement, the engagement element being mateable with the transport element of the tower; and wherein when the engagement element of the clamp is mated with the transport element of the tower, the apparatus is configured to allow for lifting and lowering of the structure at the site from the base of the tower using the clamp.

GB 2582844 B (W3G MARINE LTD) discloses a method of assembling a structure, such as a wind turbine, the method comprising the steps of:
providing a lifting arrangement comprising:
   a gantry disposed over and/or directly above a rail or rails; and
   lifting means coupled to the gantry; and
stacking portions of the structure by:
   conveyably disposing a first portion of the structure relative to the rail or rails by:
      lifting the first portion using the lifting means;
      configuring a clamping device to grip the first portion; and
      conveying the clamping device along the rail or rails;
   lifting a second portion of the structure using the lifting means;
   disposing the first portion underneath the second portion by further conveying the first portion gripped by the clamping device along the rail or rails; and
   lowering the second portion onto the first portion.

CN 213445838 U (NANTONG RUNJINI MARINE EQUIPMENT CO, LTD) describes an offshore wind turbine blade wave compensation platform, including two tracks, fixedly connected with a portal between the relative one side of the track, equal fixedly connected with servo motor all around an inboard bottom of the portal.

EP 2058444 A2 (FREYSSINET) describes a method of building a civil engineering structure and associated system. The method involves positioning a second element under a fixed gantry crane comprising a lifting unit e.g. crane hook. The element is lifted using the lifting unit. A first element is positioned under the fixed crane and below the second element. The second element is placed on the first element using the lifting unit. The fixed crane is located on or near a construction bench, on which a civil structure is constructed. An independent clause is also included for a system for constructing a civil structure, comprising a fixed lifting structure.

One or more aspects/embodiments of the invention may or may not address one or more of the background issues.

It is an object of at least one embodiment of at least one aspect of the present invention to obviate or at least mitigate at least one problem in the prior art.

It is an object of at least one embodiment of at least one aspect of the present invention to provide a technically simple and/or commercially more cost-effective method and system for assembling an (offshore) wind turbine structure or (offshore) jacket, e.g., for an (offshore) wind turbine, than in the prior art.

### SUMMARY OF INVENTION

According to the present disclosure there is provided a device or apparatus and a system for assembling an (offshore) structure (such as a wind turbine or wind turbine generator (WTG)), a method of deploying a device or apparatus for assembling an (offshore) structure, and a method of assembling an (offshore) structure according to the appended claims and/or clauses.

According to a first aspect of the present disclosure there is provided a device or apparatus for assembling a structure (such as wind turbine or jacket, such as an offshore structure, wind turbine or jacket), the apparatus comprising a (erectable, e.g., vertically erectable) structure and a lifting arrangement.

The structure may be capable of being erected or assembled, e.g., in situ, and/or capable of being takedown or disassembled, e.g., in situ.

The device/apparatus may comprise or provide an assembly area, e.g., an area of water, e.g., above a bed or floor of a body of water, e.g., a seabed. The assembly area may be provided below the lifting arrangement, e.g., when erected. It will be appreciated that the device/apparatus can be used offshore or on land, e.g., on or at a quayside.

The assembly area may be provided within a perimeter, area or volume of the device or apparatus. The lifting arrangement may be provided above, e.g., directly above, the assembly area.

In one embodiment, the (erectable) structure may be disposable in a first or collapsed state. The erectable structure may be disposable in a second, expanded or erected state. The erectable structure may be expandable or selectively movable from a/the first state to a/the second state. The erectable structure may be collapsible or further selectively movable from a/the second state to a/the first state. This selective disposition may facilitate the erectable structure being transported in a collapsed state to a location for assembling the (offshore) structure and then when at the location being expanded and erected. Further, this selective disposition may facilitate the erectable structure being collapsed and/or removed from the assembly area after the (offshore) structure has been assembled.

In another embodiment, the structure may be capable of being assembled and/or erected at site or in situ. This embodiment facilitates parts of the structure being transported to site individually or at least not assembled for assembly on or at site.

The structure may comprise a plurality of legs and/or an apex member. The legs may be connected to or connectable to the apex member.

The lifting arrangement may, in use, be provided below, e.g., directly below the apex member. The lifting arrangement may depend from the apex. The assembly area may be provided below, e.g., directly below, the apex.

In one preferred embodiment, the device or apparatus may comprise a tripod or tripod arrangement or comprise three legs. The tripod may comprise three legs. Alternatively, the device or apparatus may comprise a tetrapod.

Each of the legs may be attached, e.g., hingably attached, at a first end to a connection member. The connection member may comprise an apex of the structure/tripod/tetrapod. The lifting arrangement may be attached to and/or depend (vertically downwardly) from the connection member or apex. In this manner, the lifting arrangement may be provided between the three legs.

Each leg may be provided at a second end with a mud mat. The/each mud mat may be selectively buoyant (for transportation) or submersible (for erection).

In some embodiments, e.g., in the case of a tetrapod, a pair of opposing legs may be of a same length, which length may be different to another pair of opposing legs.

The structure may when erected comprise a pyramid shape, e.g., a pyramid having a polyhedral base, triangular base, square base or rectangular base, The structure may when erected comprise a tetrahedron.

The lifting arrangement may comprise an arrangement for connecting or supporting a part(s) of the structure to be lifted. The arrangement may comprise one or more hooks, shackles or the like. The lifting arrangement may comprise a single point lifting arrangement, e.g., comprising a single lifting point for supporting a load, e.g., part or component of the structure.

The lifting arrangement may comprise one or more pulley arrangements and/or winches.

One or more lines (control/mooring/tagging lines) may be provided between at least one and preferably each of the legs, the lines being adapted to be connected to a load (e.g., part of the structure) being lifted by the lifting arrangement. A connection piece may be provided at an intersection point of the lines, e.g., below the apex member.

One or more of the legs of the device or apparatus may comprise a (metal) lattice arrangement.

At or near ends of the legs distal the apex member, there may be provided further lines or cables between adjacent legs.

Yet further lines may be provided at or near end of each leg, which further lines extend (horizontally) so as to meet at a (base) centre point of the apparatus, e.g., below the apex member.

In a modified embodiment the device/apparatus at least one or each leg may be provided with a support member. The/each support member may be provided at or near a respective end of one of the legs distal the apex. The/each support member may be deployed in a substantially vertical disposition, in use. The support member may impart support/strength to the respective leg so as to seek to avoid buckling of the leg.

According to a second aspect of the present disclosure there is provided a system for assembling a structure (such as wind turbine or jacket, such as an offshore structure, wind turbine or jacket), the system comprising a device according to the first aspect of the present disclosure.

The system may comprise a floating or buoyant body for transporting one or more parts of the structure to the assembly area.

The system may comprise one or more winches, e.g., for controlling the lifting arrangement.

The one or more winches may be provided on a further floating or buoyant body. The further floating or buoyant body may be adapted to be secured to a leg of the device or apparatus. For example, the further floating or buoyant body may comprise a slotted or recessed portion for engagement with a leg of the device or apparatus and/or for receiving the connection member during transportation of the device/apparatus when in a collapsed state.

According to a third aspect of the present disclosure there is provided a method of deploying a device or apparatus for assembling a structure such as a wind turbine, such as an (floating/buoyant) offshore structure, wind turbine or jacket, the method comprising:
providing at or to an assembly area or location a device or apparatus according to the first aspect of the present disclosure ; and
deploying/erecting the device or apparatus.

Preferably the assembly location is an area of water, e.g., an area above a bed or floor of a body of water, e.g., a seabed.

The device/apparatus when erected may stand/sit on a bed of a body of water, e.g., a seabed. The apex and the lifting arrangement may be provided above a surface level of the body of water.

The step of providing the device or apparatus to the assembly location may comprise use of one or more vessels or barges, e.g., to transport the device or apparatus or one or more parts/components thereof, whether together or individually.

According to a fourth aspect of the present disclosure there is provided a method of assembling a structure or wind turbine, such as an offshore structure, wind turbine or jacket, the method comprising:
deploying the device or apparatus according to a method according to the third aspect of the present disclosure;
transporting a first part of the structure to the assembly area;
lifting the first part using the lifting arrangement;
transporting a floating/buoyant base or foundation body to the assembly area;
connecting/clamping the first part of the structure to the floating/buoyant base body.

The method may comprise the subsequent step(s) of:
transporting a further part of the structure to the assembly area;
lifting the further part using the lifting arrangement;
transporting the floating/buoyant base to the assembly area;
lowering and/or connecting the further part of the structure to the first/a part of the structure already provided on the floating/buoyant base.

The structure may be a floating structure.

The structure may comprise or include:
a plurality of parts or components;
a segmented (offshore) structure;
a floating/buoyant foundation;
a monopile;
a jacket, e.g., a three-leg jacket, a four-leg jacket or a twisted jacket.

In the case of the structure comprising a wind turbine, (the) parts or components may comprise one or more of:
column or tower, e.g., first and second column parts;
a nacelle;
a plurality of turbine blades, e.g., three turbine blades.

In such case, there could be a given number of parts, e.g., six parts, and so a requirement for a same given number of lifts, e.g., six lifts.

The method may comprise a tower for supporting (parts of) the structure during assembly.

There may be provided an arrangement for extending or increasing a height of the tower, in use, e.g., in intervals, so as to lift the structure and/or apex of the structure.

According to a fifth aspect of the present disclosure there is provided a method of assembling an (offshore) structure, such as an (offshore) wind turbine or (offshore) jacket, the method comprising the steps of:
providing a lifting arrangement comprising:
   a gantry disposed over and/or directly above an area of water; and
   a lifting means or apparatus coupled to the gantry; and stacking portions of the structure by:
   conveyably disposing a first portion of the structure relative to or at the area of water:
   lifting the first portion using the lifting means;
   configuring a clamping or retaining device to grip the first portion; and
   conveying the clamping or retaining device away from the area of water;
   lifting a second portion of the structure using the lifting means;
   disposing the first portion underneath or adjacent the second portion by further conveying the first portion gripped by the clamping device to the area of water; and
   lowering the second portion onto or so as to connect with the first portion.

The step of lifting the second portion using the lifting means or apparatus may comprise hoisting and/or raising the second portion in an upwards direction to a height above an uppermost level of first portion.

The method may comprise a step of fixedly coupling the second portion to the first portion by bolting, welding, and/or clamping.

The structure may be a wind turbine assembly, such as an offshore wind turbine, or a jacket, such as an offshore jacket, e.g., for supporting a wind turbine.

The first portion and/or the second portion and/or one or more further portion(s) may be at least one of: a portion of a tower or a nacelle or a turbine blade(s).

The method may further comprise the step of stacking a/the further portion on the second portion by:
lifting the further portion using the lifting means or apparatus;
disposing the second portion of the structure underneath the further portion by conveying the second portion to the area of water;
lowering the further portion onto or relative to the second portion.

The clamping device may be provided on a floating or buoyant body, e.g., a floating foundation or (top) crown assembly.

The clamping device may be configured for supporting and/or clamping and/or gripping at least a portion of the structure in a vertical disposition and/or substantially upright configuration.

According to a sixth aspect of the present disclosure there is provided a system for assembling a structure, such as an (offshore) wind turbine or (offshore) jacket, the system comprising:
a gantry disposed over and/or directly above an area of water;
a lifting means or arrangement coupled to the gantry; and
a means or device for conveying a portion of the structure to and from the area of water, wherein
the means or device for conveying a portion of the structure comprises a clamping or retaining device.

The clamping or retaining device may be configurable between a clamping or retention configuration for gripping a portion of the structure and a non-clamping or non-retention configuration.

The clamping device may be coupled to or mounted on a floating or buoyant (base) body, e.g., a floating foundation or (top) crown assembly or barge.

The lifting means may comprise a winch and/or a pulley.

The system may be adapted for assembling a wind turbine assembly or a jacket, such as an offshore wind turbine assembly or an offshore jacket assembly, e.g., for a wind turbine.

The system may comprise a clamping and/or gripping system comprising:
the clamping device for gripping at least a portion of a wind turbine assembly; and
a/the floating or buoyant body,
wherein the clamping device is mounted on the floating or buoyant body.

The clamping device may be configured for supporting at least a portion of a wind turbine assembly or jacket assembly in a vertical disposition and/or substantially upright configuration.

The clamping device may be configured to engage with a flange or rim disposed on an outer surface of the portion of the structure.

According to a seventh aspect of the present disclosure there is provided a device or apparatus for assembling a structure (such as wind turbine or jacket, such as an offshore structure, wind turbine or jacket), the device or apparatus comprising an erectable, e.g., vertically erectable structure. The device or apparatus may comprise a lifting arrangement. Also disclosed is a method of erecting the erectable structure, and a system comprising the erectable structure.

The erectable structure may comprise a multi-legged structure, e.g. a tripod or tetrapod or the like.

In one embodiment, the erectable structure may be disposable in a first or collapsed state. The erectable structure may be disposable in a second, expanded or erected state. The erectable structure may be expandable or selectively movable from a/the first state to a/the second state. The erectable structure may be collapsible or further selectively movable from a/the second state to a/the first state. This selective disposition may facilitate the erectable structure being transported in a collapsed state to a location for assembling the (offshore) structure and then when at the location being expanded and erected. Further, this selective disposition may facilitate the erectable structure being collapsed and/or removed from the assembly area after the (offshore) structure has been assembled.

In examples, erection of the erectable structure may be assisted by a post or column. The post or column may be mounted on a floating structure. The post or column may extend through a central portion of the erectable structure.

During a process of erection of the erectable structure, a central portion of the erectable structure may be raised relative to, e.g. ‘walked’ up, the post or column.

The central portion may comprise or may be coupled to, a running gear module.
Such raising of the central portion of the erectable structure comprises use of one or more clamps, such as a walking clamp.

In some examples, while the central portion of the erectable structure is being raised, a pulling force may be applied to tension members, e.g. lines, between a centre and a base (or generally towards a base) of legs of the erectable structure.

In some examples, while the central portion of the erectable structure is being raised, a pulling force may be applied to tension members, e.g. lines, between the bases of the legs of the erectable structure.

The post may be provided initially on a floating structure with the top of the erectable structure placed around the post or column.

In examples, the erectable structure and/or the post or column may be initially provided in pieces that may be assembled, e.g. joined together, on deck.

In examples, the erectable structure may be installed in pieces that are then joined together on the deck and/or lowered over the top of, and/or assembled around, the post or column.

In some examples, the floating structure, or at least a portion thereof, may be lowered to and/or extended to the seabed to provide a reaction to lift the erectable structure into position.

In some examples, the floating structure may be floating during erection of the erectable structure, e.g. providing there is sufficient buoyancy and stability capacity to react the loads.

In some embodiments, the post or column may be fitted with one or more winches, e.g. linear winches, at an upper or top portion.

The one or more winches may be configured to lift an upper or top portion of the erectable structure.

In embodiments, the post or column may be provided with one or more return sheaves with winches at, on, or in the general proximity of, the deck, e.g. a deck of the floating structure.

The post or column may be a primary post or column and may comprise at least one further post or column disposed inside the primary post or column. The primary post or column and the at least one further post or column may be arranged in a telescopic arrangement.

During assembly of the erectable structure, when an upper portion or top of the erectable structure is raised to reach the top or upper portion of the post or column, then the at least one further post or column may be extended, e.g. telescoped, to continue with a process of raising the upper portion or top of the erectable structure.

In some examples, the erectable structure may be erected without any lifting machinery in place, e.g. lifting machinery that may be required for assembling the structure, such as the wind turbine or jacket or offshore structure, offshore wind turbine or offshore jacket.

In such examples, the lifting machinery may be lifted into place, e.g. at an upper portion of the erectable structure, following erection of the erectable structure.

In some examples, the erectable structure may have some of its structural components lifted into place following the initial erection of the structure. In an example, such structural components may also form part of a platform for the lifting machinery.

In examples of use, the lifting machinery may be configured to be lowered and/or removed, such as for purposes of servicing, maintenance, repair, preservation and the like.

In some examples, a windage of the erectable structure may be reduced by removing at least a portion of the erectable structure, and in particularly an upper portion of the erectable structure. As an example, roofs or safe areas for personnel that may only be required during operations may be removed to reduce the windage.

In some examples, one or more parts or components of the erectable structure that are lifted after an initial erection of the erectable structure may be used to increase a stiffness of the erectable structure, in order to reduce a propensity to buckling.

In some examples, such as when the erectable structure comprises a tripod, there may be provided a mud-mat barge at a base portion of each leg. Such barges may be fitted with buoyancy that may extend from their deck and, when on the seabed, their tops or upper portions may be substantially at or above a waterline. Advantageously, this may assist with the sinking of the mud-mat barges into place.

In some examples, the mud-mat barges may be ballasted such that said mud-mad barges provide lateral stability from forces, e.g. wind and/or tidal forces, during their operations. In some example, such ballast may be achieved by at least one of: pumping in water or other higher density material to provide a gravity anchor, e.g. mud or haematite; sheet piles around the mud-mat barge; piled anchors; suction anchors; anchors attached by chain; wire or rope; and/or securing lines to the shore.

According to an eighth aspect of the present disclosure there is provided a system for assembling a structure (such as wind turbine or jacket, such as an offshore structure, wind turbine or jacket), the system comprising a device or apparatus according to the seventh aspect of the present disclosure.

According to a ninth aspect of the present disclosure there is provided an apparatus for assembling a structure such as a wind turbine or jacket. The apparatus comprises a first structure, e.g. an erectable structure, comprising a first plurality of legs connected by a first connection arrangement. The apparatus comprises a second structure, e.g. a second erectable structure, comprising a second plurality of legs connected by a second connection arrangement. The apparatus comprises an elongate structure extending between the first and second erectable structures. The apparatus comprises a lifting arrangement configurable to move a load along the elongate structure between the first and second erectable structures.

Advantageously, provision of the first and second erectable structures, together with the lifting arrangement configurable to move a load along the elongate structure between the first and second erectable structures, enables assembly of a structure, such as a wind turbine, without having to repeatedly move any base or foundation upon which the structure may be assembled. That is, in use, components of the structure may be provided under the first structure, and then lifted to an assembly site under the second structure by the lifting arrangement. A reduction in movement of any base or foundation upon which the structure may be assembled may advantageously reduce operating costs, decrease an assembly time, reduce a complexity of an assembly operation and/or recue risk to personnel.

The first and/or second erectable structure may be disposable in a first or collapsed or stowed state and a second or expanded state. The first and/or second erectable structure may be expandably erectable or selectively movable from the first state to the second state. The first and/or second erectable structure may be collapsible or stowable or further selectively movable from the second state to the first state.

Advantageously, the first and/or second erectable structures may be transported to an assembly site in the first or collapsed or stowed state. This may advantageously reduce transportation costs, and increase a range of locations at which the disclosed apparatus may be used.

As described in more detail below, when erected the apparatus may define and/or comprise an assembly area, e.g., an area of water, e.g., above a bed or floor of a body of water, e.g., a seabed, below the lifting arrangement. The assembly area may be provided below, e.g., directly below, the lifting arrangement, e.g., when erected. The assembly area may be provided within a perimeter, area or volume of the device or apparatus. The lifting arrangement may be provided above, e.g., directly above, the assembly area.

The first connection arrangement may comprise a first apex member substantially defining a first apex of the first plurality of legs.

That is, the first plurality of legs may be arranged to meet, or substantially meet, at a point defined by the first connection arrangement. As such, in some embodiments, the first plurality of legs together with the first connection arrangement may define a substantially pyramidal structure, where the first connection arrangement defines an apex of the substantially pyramidal structure. The first connection arrangement may comprise a plurality of components, such as struts, trusses and/or couplings.

The second connection arrangement may comprise a second apex member substantially defining a second apex of the second plurality of legs.

For example, in some embodiments the second plurality of legs may also form, or meet at, an apex. As described in more detail below, in some embodiments the second plurality of legs together with the second apex member may form a pair of shear legs or an A-frame.

The elongate structure may extend directly below the first apex and/or the second apex.

Advantageously, by extending directly below the first apex and/or the second apex, the first and second erectable structures may provide a maximum amount of structural support to the elongate structure, thereby ensuring a sufficiently heavy load can be lifted by the lifting arrangement without damaging or excessively straining the first and second erectable structures.

The first erectable structure may comprise a tripod or tripod arrangement. The first plurality of legs may have exactly three legs.

In some examples, the first erectable structure may substantially correspond to the (erectable, e.g., vertically erectable) structure of the first aspect.

The first erectable structure may comprise a tetrapod or tetrapod arrangement. The first plurality of legs may have exactly four legs.

That is, in some embodiments the first erectable structure may be formed from, for example, one or more gantry cranes, or the like.

The second erectable structure may comprise a tripod or tripod arrangement. The second plurality of legs may have exactly three legs.

In some examples, both the first and second erectable structures may each comprise tripod arrangements.

The second erectable structure may comprise a pair of shear legs. The second erectable structure may comprise a pair of shear legs or an A-Frame arrangement. The second plurality of legs may have exactly two legs.

Advantageously, an A-Frame or pair of shear legs provides a readily installable and collapsible support structure, requiring only two legs, thereby reducing costs, complexity and installation time relative to a tripod arrangement.

In a particular embodiment, the first erectable structure may be implemented as a tripod arrangement having three legs and the second erectable structure may be implemented as a pair of shear legs or an A-Frame arrangement.

Each leg of the first plurality of legs may be attached at, or substantially at, a respective first end to the first connection arrangement.

Each leg of the second plurality of legs may be attached at, or substantially at, a respective first end to the second connection arrangement.

The first and/or second connection arrangements may each comprise one or more components. For examples, the first and/or second connection arrangements may each comprise trusses, struts or the like, and may be coupled to the legs by couplings, such as pins, bolts or the like.

Each leg of the first and second plurality of legs may be provided at a respective second end with a mud mat. Optionally the/each mud mat may be selectively buoyant or submersible.

In some example embodiments a mud mat may be shared between at least one leg of the first plurality of legs and at least one leg of the second plurality of legs.

Each leg of the second plurality of legs may be hingeably coupled at the second end with the respective mud mat.

That is, each leg of the second plurality of legs may be configured, or configurable, to pivot at the second end relative to the respective mud mat.

The elongate structure may comprise a beam or truss. Optionally, the elongate structure may comprises a rail, channel or guide along which at least a portion of the lifting arrangement may be configured to be moved or conveyed.

A cantilevered portion of the elongate structure may extend from the second erectable structure in a direction away from the first extendable structure.

In an example of a use case, the cantilevered portion may be used for installation of blades on a wind turbine structure.

Optionally, the cantilevered portion may be a tapered portion.

In an example, the cantilevered portion may be tapered because the cantilevered portion has lesser weight-bearing requirements than a main portion of the elongate structure. In a non-limiting example, a main portion of the elongate structure may be configured, e.g. comprise suitable dimensions and structural integrity, to support a weight in the region of 1,200 tonnes, which may be sufficient for lifting portion of a tower structure and/or a nacelle of a wind turbine. In such a non-limiting example, a tapered, cantilevered portion of the elongate structure may be configured, e.g. comprise suitable dimensions and structural integrity, to support a weight in the region of 200 tonnes, which may be sufficient for lifting a blade of a wind turbine structure.

Advantageously, a tapered portion may require less material, incurring less associated weight and manufacturing costs, than a non-tapered portion.

The lifting arrangement may comprise an arrangement for connecting or supporting a part of the structure to be assembled.

For example, the lifting arrangement may comprise at least one of a pulley, a winch, a line, a hook, or the like. The lifting arrangement may comprise a device, such as a lifting clamp, grabbing device, support platform, cage or the like, for supporting and/or holding and/or securing a component to be lifted by the lifting arrangement.

The lifting arrangement may comprise one or more hooks or shackles.

The lifting arrangement may comprise a single point lifting arrangement.

The lifting arrangement may comprise one or more pulley and/or winch arrangements.

At least one, or each, leg of the first and/or second plurality of legs may comprise a lattice or truss arrangement.

Each leg of the first and/or second plurality of legs may be configured to be extendable.

Optionally, each leg of the first and/or second plurality of legs may be configured to extend by insertion of an extension portion to the respective leg.

In some examples, extension of one of more legs may be implemented without substantially collapsing or substantially deconstructing either of the first or second structures. For example, extension of a leg may be achieved by supporting the leg, lengthening the leg such as providing a gap or space between portions of the leg, and insertion of the extension portion, which may comprise at least one beam, truss, strut or the like.

According to a tenth aspect of the disclosure, there is provided a system for assembling a structure such as a wind turbine or jacket, comprising the apparatus according to the ninth aspect.

The system may comprise a first body for transporting one or more parts of the structure to an assembly area provided below at least a portion of the lifting arrangement. The first body may be a floating or buoyant body. Optionally, the system may comprise a first stabilizing arrangement for stabilizing the first body relative to a bed or floor of a body of water below the lifting arrangement.

The first body may, for example, comprise a barge, vessel or the like.

The system may comprise a second body for assembling the structure on. Optionally, the system may comprise a second stabilizing arrangement for stabilizing the second body relative to a bed or floor of a body of water below the lifting arrangement. Optionally, the second body may be a floating or buoyant body.

The second body may, for example, comprise a barge, vessel or the like.

Advantageously, by stabilizing the second body, the structure may be effectively assembled on a static platform support. This may reduce risk of damage to components of the structure during assembly, may mitigate the impacts of weather, tides, currents and the like upon assembly procedures, and may simplify an assembly process.

Similarly, in embodiments wherein the first body is also stabilized, components of the structure may be lifted from an effectively static body to be assembled on an effectively static platform support, e.g. a static-to-static lift. Again, this may further reduce risk of damage to components of the structure during assembly, may mitigate the impacts of weather, tides, currents and the like upon assembly procedures, and may simplify an assembly process.

The first and/or second stabilizing arrangement may comprise at least one panel or member. The at least one panel or member may comprise an inflatable element. The at least one panel or member, e.g. the inflatable element, may comprise at least one layer of a drop-stitch material, e.g. a drop-stich inflatable material.

In an example, a drop-stitch material, or a panel, member, element or the like formed from a drop-stitch material, may be configured to adopt a particular desired shape or configuration when inflated. Furthermore, the drop-stich material (or said element, member or the like formed from such a material) may be substantially rigid when inflated.

For example, a panel, or a stack of panels, of a drop-stitch material may provide a temporary buoyancy under the first or second body instead of (or in some example embodiments, in addition to) using a barge or a vessel.

Advantageously, use of a drop-stitch material may provide a means of having a controllable volume of air, and hence a controllable means of creating a stabilizing buoyancy.

In an example, an inflatable bag, in which the volume of the inflated portion can be controlled, may be placed under the body, e.g. under a hull of the body, and then inflated, thereby reducing a draft. The body could then be lowered to the seabed using the variable buoyancy, e.g. in a same way as a submersible barge.

According to an eleventh aspect of the disclosure, there is provided a method of deploying an apparatus for assembling a structure such as a wind turbine or jacket. The method comprises providing at or to an assembly area or location an apparatus according to the ninth aspect. The method comprises deploying/erecting the apparatus.
Deploying/erecting the apparatus may comprise erecting the first erectable structure, such that the first erectable structure when erected stands/sits on a bed of a body of water.

Deploying/erecting the apparatus may comprise erecting the second erectable structure, such that the second erectable structure when erected stands/sits on the bed of the body of water.

In an example, at least one line or chain extending from and/or through the first erectable structure may be used to erect the second erectable structure. That is, the legs of the second erectable structure may be assembled and/or coupled in a first position, e.g. a substantially horizontal disposition, and then the one or more lines may be used to apply a pulling force to the second erectable structure to move the second erectable structure into a second position, e.g. in a more upright orientation.

Deploying/erecting the apparatus may comprise using at last one lifting device, such as a lifting device coupled to the first erectable structure and/or the second erectable structure, to lift the elongate structure.

Deploying/erecting the apparatus may comprise coupling the elongate structure to the first and second erectable structures.

In a particular embodiment, the elongate structure may be lifted and coupled to the first and second erectable structures after erection of the first and second erectable structures.

In some embodiments, the elongate structure may be configured to be decoupled and/or lowered down from the first and second erectable structures, e.g. without collapsing or deconstructing the first and second erectable structures. Advantageously, this may allow the elongate structure to be transported for maintenance.

In some embodiments, the elongate structure may be configured to elevate, e.g. lift, itself from a supporting body, e.g. a barge, to a position for coupling to the first and second erectable structures. For example, the lifting arrangement, e.g. the lifting arrangement normally used for assembly of a structure, which may be coupled to the elongate structure may be configured to lift the elongate structure to a position suitable for coupling the elongate structure to the first and second erectable structures.

Furthermore, such a static-to-static lift arrangement may advantageously allow use of relatively shallow assembly ports.

The elongate structure may be provided with the lifting arrangement. The lifting arrangement may be configurable to move the load along the elongate structure between the first and second erectable structures. After deployment/erection of the apparatus, the lifting arrangement may be provided above a surface level of the body of water.

Erecting the second erectable structure may comprise coupling, with a hingeable arrangement, an end of each of the second plurality of legs to a respective support structure, such as a mud mat. Each of the second plurality of legs may be disposed to extend in a first direction in a/the first or collapsed or stowed state.

Deploying/erecting the apparatus may comprise transitioning the second erectable structure from the first or collapsed or stowed state and to a/the second or expanded state by rotating each of the second plurality of legs about the hingeable arrangement such that each of the second plurality of legs is disposed to extend in a second direction.

The second direction may be more upright than the first direction.

That is, in an example the first direction may be a substantially horizontal direction, and the second direction may be closer to a vertical direction that the first direction.

In some examples, the second erectable structure may be lowered and/or collapsed and/or deconstructed when not in use. Advantageously, this may reduce visual intrusion. In examples, the second erectable structure may be lowered and/or collapsed and/or deconstructed by pivoting the second erectable structure on the hingeable arrangement point and/or reacting from the first erectable structure.

According to a twelfth aspect of the present disclosure, there is provided a method of assembling a structure, such as a wind turbine or a jacket. The method may comprise deploying the apparatus according to the method of the eleventh aspect.

The method may comprise disposing a first base or body at the assembly area substantially below at least a portion of the first erectable structure.

The method may comprise disposing a second base or body at the assembly area substantially below at least a portion the second erectable structure.

The method may comprise assembling the structure by configuring the lifting arrangement to lift a component of the structure from the first base or body towards the second base or body.

The first base or body may comprise a floating/buoyant barge or vessel for carrying the component

Disposing the first base or body at the assembly area may comprises stabilizing the first base or body relative to a bed or floor of a body of water below the lifting arrangement.

Stabilizing the first base or body may comprise configuring a stabilizing arrangement such as a jack to limit movement of the first base or body relative to the bed or floor. As described above, in some embodiments a stabilizing arrangement may comprise an inflatable element and/or or a panel or member comprising a drop-stitch material.

Stabilizing the first base or body may comprise mooring the first base or body. The second base or body may comprise a floating/buoyant vessel, such as a floater for a wind turbine, for supporting the assembled structure.

Disposing the second base or body at the assembly area may comprise stabilizing the second base or body relative to a/the bed or floor of a/the body of water below the lifting arrangement.

Optionally, stabilizing the second base or body may comprise disposing the second base or body on a grounded vessel.

Optionally, stabilizing the second base or body may comprise disposing the second base or body on a floating vessel.

Optionally, stabilizing the second base or body may comprise disposing the second base or body on the seabed.

As described above, in some embodiments a stabilizing arrangement to stabilize the second base or body, e.g. a floater, may comprise an inflatable element and/or or a panel or member comprising a drop-stitch material.

Optionally, stabilizing the first base or body may comprise controlling a volume or air in one or more inflatable elements disposed below and/or around at least a portion of the second base or body.

Advantageously, this may allow the use of more assembly locations, as the assembled structure, e.g. a turbine, may be floated off the second base or body at a deep-water location.

Optionally, stabilizing the second base or body may comprise mooring the second base or body.

Optionally, stabilizing the second base or body may comprise controlling a volume or air in one or more inflatable elements disposed below and/or around at least a portion of the second base or body.

The structure may comprise or include: a plurality of parts or components; a segmented (offshore) structure; a floating/buoyant foundation; a monopile; or a jacket, e.g., a three-leg jacket, a four-leg jacket or a twisted jacket.

In the case of the structure comprising a wind turbine, the wind turbine may comprise a plurality of parts or components comprising one or more of: a column or tower section; a nacelle; a plurality of turbine blades.

According to a further aspect of the disclosure, there is provided a method of assembling an offshore wind turbine, such as a floating offshore wind turbine. The method comprising the steps of: transporting, on one or more vessels, a nacelle and a tower of the offshore wind turbine to an assembly area below a support apparatus; suspending the tower and the nacelle from the support apparatus; transporting a floating/buoyant base or foundation body to the assembly area below the support apparatus; and landing the tower on the floating/buoyant base or foundation body and the nacelle on the tower.

Advantageously, by suspending the nacelle and the tower of the offshore wind turbine from the support apparatus, a quantity of marine operations, e.g. operations manoeuvring the vessel around/to/from the support apparatus, required to assemble the offshore wind turbine may be reduced compared to other methods described herein. A relative reduction in the quantity of marine operations may reduce costs, improve safety, reduce assembly time, and simplify the assembly of the offshore wind turbine.

Furthermore, as described in more detail below, in some example embodiments both the support apparatus and the floating/buoyant base or foundation body may be grounded relative to a bed or floor of a body of water at the assembly area. As such, the disclosed method optionally provides a static-to-static lift operation for installing the nacelle on the tower, reducing a risk of damage to the tower and nacelle and simplifying assembly operations.

The nacelle and the tower may be transported to the assembly area together on a single vessel.

Advantageously, only a single marine operation may be required to transport the nacelle and the tower to the assembly area. In some embodiments, the blades may be transported on the same vessel. In some embodiments, some or all portions of the tower may be transported on a first vessel, and the nacelle may be transported on a further vessel. The vessel may be a ship, barge or the like. The vessel may comprise a barge known in the art as a feeder barge.

It will be understood that the nacelle may be a component of the wind turbine configured to sit atop the tower and may, for example, comprise at least one of: a housing; a gearbox; a low-speed shaft; a high-speed shaft; a generator; a brake.

The tower may comprise a plurality of tower portions, e.g. portions for assembling into the tower. The tower may be transported to the assembly area in a disassembled state. The method may comprise a step of assembling the tower on the one or more vessels from the plurality of tower portions before the (assembled) tower is suspended from the support apparatus.

The method may comprise using a lifting arrangement of the support apparatus to stack the plurality of tower portions to assemble the tower.

The lifting arrangement may comprise an arrangement for connecting or supporting a part(s) of a structure or component to be lifted. The arrangement may comprise one or more hooks, shackles or the like. The lifting arrangement may comprise a single point lifting arrangement, e.g., comprising a single lifting point for supporting a load, e.g., part or component of the structure. The lifting arrangement may comprise one or more pulley arrangements and/or winches. The system may comprise one or more winches, e.g., for controlling the lifting arrangement. For example, the lifting arrangement may comprise at least one of a pulley, a winch, a line, a hook, or the like. The lifting arrangement may comprise a device, such as a lifting clamp, grabbing device, support platform, cage or the like, for supporting and/or holding and/or securing a component to be lifted by the lifting arrangement.

The vessel may comprise a seafastening grillage for supporting the plurality of tower portions. Optionally, the grillage may be raised to allow access by personnel to an interior of each tower portion.

Suspending the nacelle from the support apparatus may comprise using one or more lines or slings to suspend the nacelle in a holding position. Optionally, the holding position may be offset from a vertical axis extending through an apex of the support apparatus.

That is, the nacelle may be effectively stored on the support apparatus, e.g. below an apex member of the support apparatus, until it is required for landing on the tower.

In some embodiments, the nacelle is suspended from the support apparatus prior to assembly and/or suspension of the tower. In other embodiments, the tower is assembled and/or suspended from the support apparatus prior to suspending the nacelle form the support apparatus.

Landing the nacelle on the tower may comprise a step of cross-hauling the nacelle from the holding position to a landing position substantially below the apex of the support apparatus.

The floating/buoyant base or foundation body may comprise: a floater; floating spar; a tension-leg platform; a barge; or a semi-submersible platform, or the like.

The method may comprise a step of stabilizing the floating/buoyant base or foundation body relative to a bed or floor of a body of water at the assembly area using a stabilising arrangement comprising at least one of: a jack; a mooring arrangement; an anchor arrangement; and/or a grounded vessel.

Advantageously, stabilizing the floating/buoyant base or foundation body relative to the bed or floor of a body of water may enable static-to-static lift operations when landing the nacelle on the tower, thereby minimising a risk of damage to the tower and/or nacelle and simplifying assembly operations.

The method may comprise a step, e.g. a subsequent step, of transporting, on a/the vessel, a plurality of blades of the offshore wind turbine to the assembly area.

The method may comprise using a/the lifting arrangement of the support apparatus to lift each of the plurality of blades for coupling to the nacelle.

In some embodiments, a further lifting arrangement may be employed for lifting each of the plurality of blades for coupling to the nacelle, as described in more detail below with reference to the drawings.

The support apparatus may comprise a cantilever portion extending from a leg and/or apex of the support apparatus. The method may comprise lifting each of the plurality of blades by one or more lines extending from the cantilever portion.

In example embodiments, the cantilever portion may be detachable from the support apparatus. In example embodiments, the cantilever portion may be configurable to selectively extend from the support apparatus, e.g. from a leg and/or apex member of the support apparatus. For example, the cantilever portion may have a hinged connection to the support apparatus.

The support apparatus may comprise an erectable tripod structure and a lifting arrangement. When the erectable tripod structure is erected, the assembly area may be provided below the lifting arrangement.

For example, the support apparatus may comprise, or may substantially correspond to, the device or apparatus for assembling a structure of the first or seventh aspect, or the apparatus for assembling a structure of the ninth aspect. The support apparatus may, for example, comprise the tripod structure depicted in FIG. 3a or the tripod structure of FIG. 26.

According to a further aspect of the disclosure, there is provided a support apparatus for assembling an offshore wind turbine, such as a floating offshore wind turbine. The support apparatus comprises an erectable tripod structure. The support apparatus comprises a lifting arrangement for lifting a tower and/or a nacelle of the offshore wind turbine. The lifting arrangement is provided above an assembly area when the tripod structure is erected. The support apparatus comprises a support arrangement for suspending the tower and/or the nacelle from the erectable tripod structure.

For example, the support apparatus may comprise, or may substantially correspond to, the device or apparatus for assembling a structure of the first or seventh aspect, or the apparatus for assembling a structure of the ninth aspect. The support apparatus may, for example, comprise the tripod structure depicted in FIG. 3a, the tripod with shear leg structure of FIG. 16, or the tripod structure of FIG. 26.

The support arrangement may comprise one or more couplings or nodes on an apex member and/or leg of the erectable tripod structure for suspending the nacelle.

The support apparatus may comprising one or more slings or lines for suspending the nacelle from the one or more couplings or nodes.

The support apparatus may comprise a cantilever portion. The cantilever portion may extend from the apex member or leg of the erectable tripod structure. The cantilever portion may be for suspending one or more blades of the offshore wind turbine.

The erectable tripod structure may be disposable in a first or collapsed state.

The erectable tripod structure may be disposable in a second or expanded state.

The erectable tripod structure may be expandable erectable or selectively movable from a/the first state to a/the second state The erectable tripod structure may be collapsible or further selectively movable from a/the second state to a/the first state.

The erectable tripod structure may be capable of being assembled and/or erected at site or in situ.

The plurality of legs of the erectable tripod structure may be connected to or connectable to an/the apex member.

The lifting arrangement may be, in use, provided below, e.g., directly below, the apex member.

Each of the plurality of legs of the erectable tripod structure may be attached, e.g., hingably attached, at a first end to the apex member.

Each leg may be provided at a second end with a mud mat. Optionally the/each mud mat may be selectively buoyant or submersible.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF DRAWINGS

Embodiments of the present disclosure will now be described, by way of example only, and with reference to the accompanying drawings, which are:

FIG. 1 a schematic view of an apparatus for assembling an offshore structure according to a first embodiment of the present disclosure, the apparatus being in transit to an offshore assembly/installation area;

FIG. 2(a) to (e) a series of views of the apparatus of FIG. 1 being deployed at an offshore location comprising an area of water;

FIG. 3(a) and (b) views of the apparatus deployed at an area of water;

FIG. 4 a view of the apparatus of FIG. 1 with an offshore structure erected at the area of water;

FIG. 5 a detailed view of an apex of the erected apparatus of FIG. 4;

FIG. 6(a) to (e) a series of schematic drawings showing a sequence of steps in erecting the offshore structure of FIG. 4;

FIG. 7(a) to (c) schematic drawings of steps in a sequence in erecting an offshore structure using an apparatus for assembling an offshore structure according to a second embodiment of the present disclosure;

FIG. 8(a) and (b) schematic drawings of steps in a sequence in erecting an alternative offshore structure using the apparatus of FIG. 1;

FIG. 9(a) to (c) a front view, a perspective view from one side and above, and an in situ view of an offshore wind turbine assembled using a device/apparatus according to the present disclosure;

FIG. 10(a) to (d) a side view, a perspective view from one side and above, a further perspective view from one side and above, and a yet further perspective view from one side an above with an offshore wind turbine in situ of an apparatus according to a third embodiment of the present disclosure;

FIG. 11(a) to (c) a perspective view and side views of main and auxiliary lifting gear of the apparatus of FIG. 10(a) to (d);

FIG. 12(a) to (d) a series of views of tagging winches of the apparatus of FIG. 10(a) to (d);

FIG. 13(a) to (i) a series of views illustrating the erection or elevation of the apparatus of FIG. 10(a) to (d);

FIG. 14 a side view with an offshore wind turbine in situ of an apparatus according to a fourth embodiment of the present disclosure;

FIG. 15a a perspective view of a running gear module, according to an embodiment of the disclosure;

FIG. 15b a line drawing of the running gear module of FIG. 15,

FIG. 16 a schematic view of an apparatus for assembling an offshore structure according to a ninth embodiment of the present disclosure, the apparatus deployed at an assembly/installation area with components of an offshore structure located on first and second assembly bodies;

FIG. 17(a) to (b) views of the apparatus of FIG. 16 with the components of the offshore structure partially erected;

FIG. 18(a) to (b) views of the apparatus of FIG. 16 with a lifting arrangement deployed and attached to a component of the offshore structure;

FIG. 19(a) to (c) a perspective view and side views of the second body for assembling the offshore structure on in a floating configuration; FIG. 20(a) to (c) a perspective view and side views of the body of FIG. 19 in a grounded configuration;

FIG. 21(a) to (c) a perspective view and side views of the body of FIG. 19 in a grounded configuration, with a component of the offshore structure in situ;

FIG. 22(a) to (b) a perspective view and side views of the body of FIG. 19 in a floating configuration, with a component of the offshore structure in situ;

FIG. 23(a) to (d) a series of perspective views illustrating the lifting of a component of the offshore structure from the first to second assembly body using the apparatus of FIG. 16;

FIG. 24 a perspective view of an offshore wind turbine in situ of the apparatus of FIG. 16;

FIG. 25 depicts a load feeder barge and components of an offshore wind turbine, for use in a method of assembling the offshore wind turbine, according to an embodiment of the disclosure;

FIG. 26 depicts a perspective view of a support apparatus according to an embodiment of the disclosure;

FIGS. 27 to 34 depicts a series of steps in the method of assembling an offshore wind turbine, according to an embodiment of the disclosure;

FIG. 35 depicts a blade feeder barge, for use in the method of assembling the offshore wind turbine, according to an embodiment of the disclosure; and

FIG. 36 depicts a step of installing the blades of the offshore wind turbine, according to an embodiment of the disclosure.

### DETAILED DESCRIPTION OF DRAWINGS

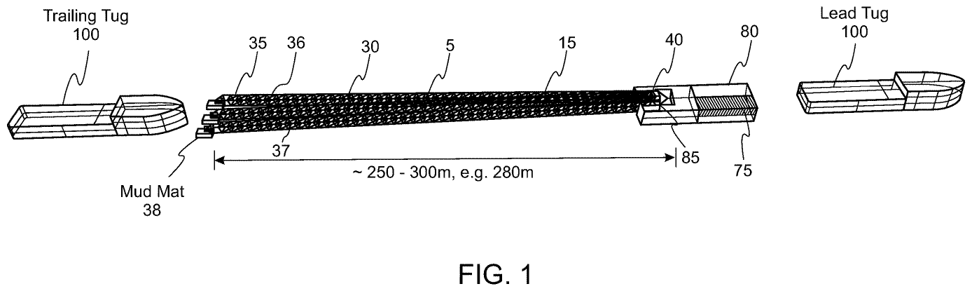

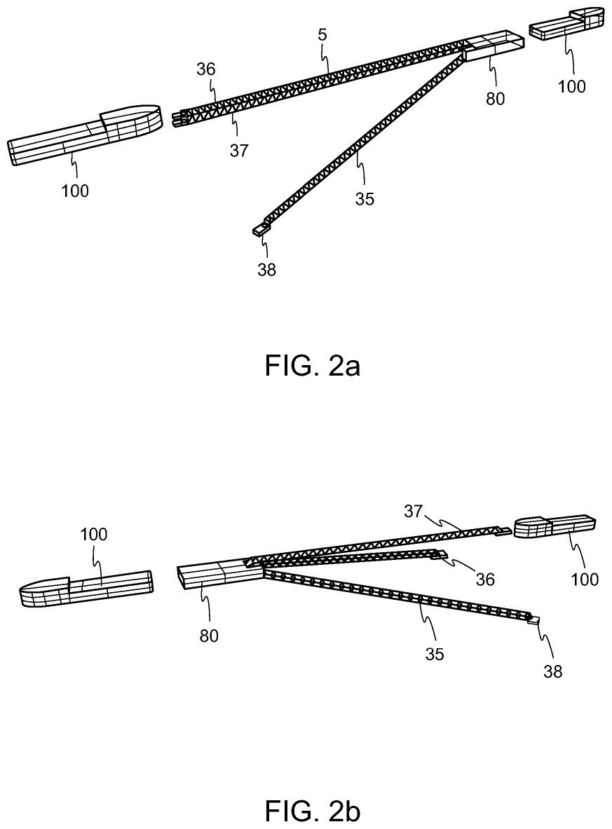

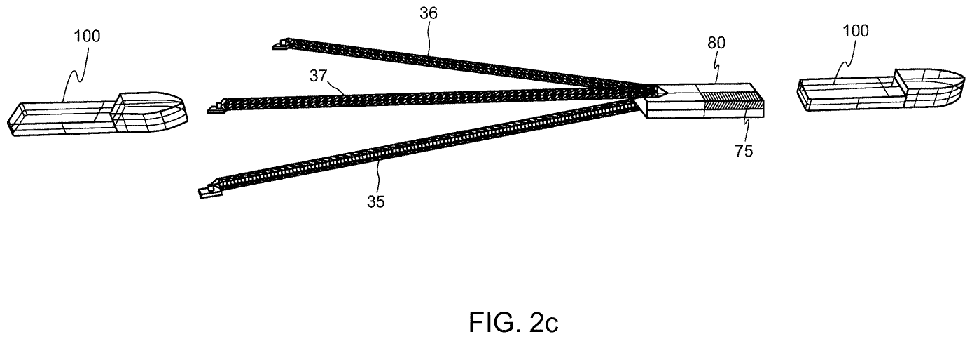

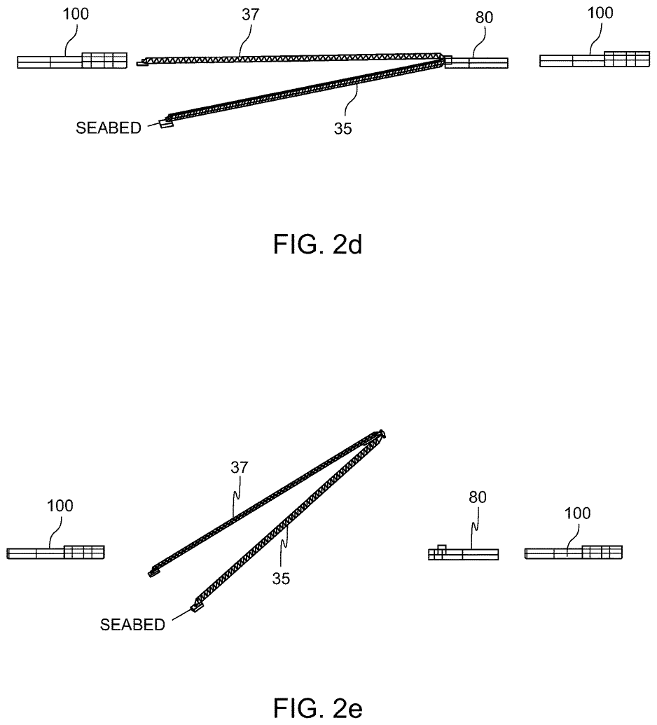

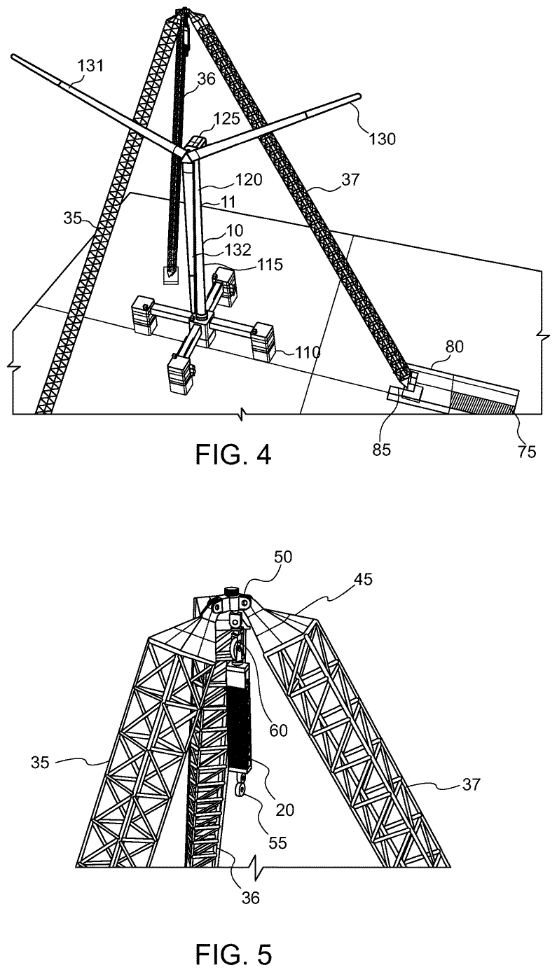

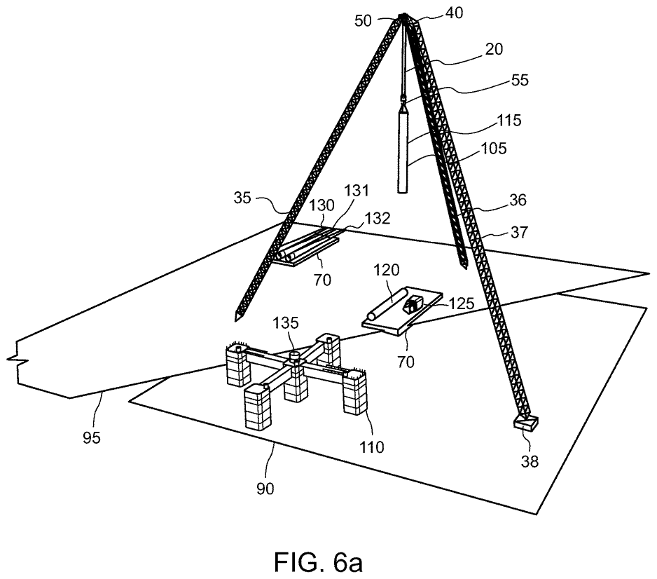

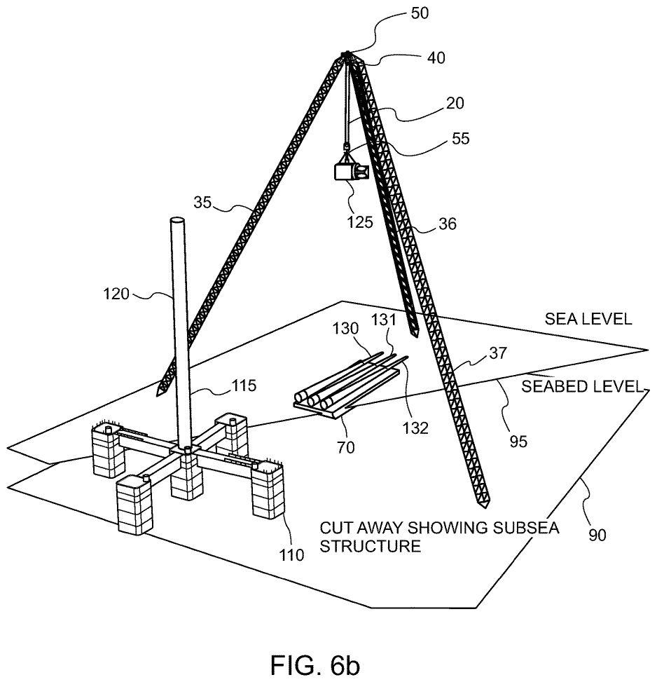

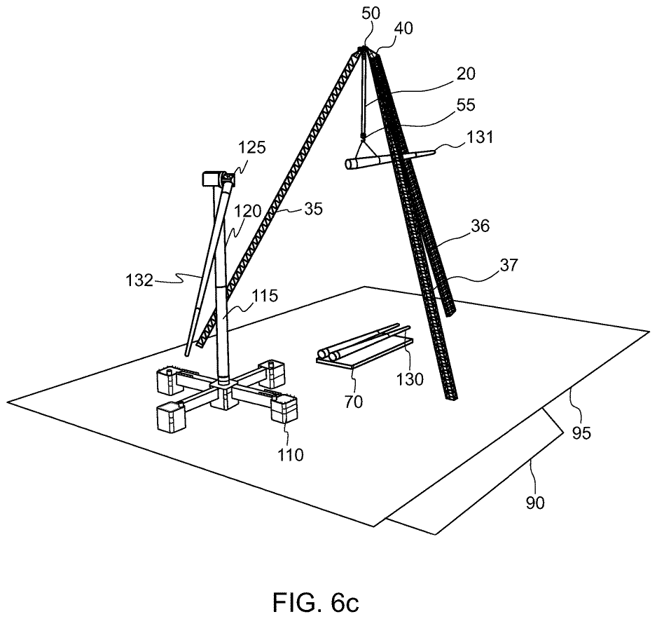

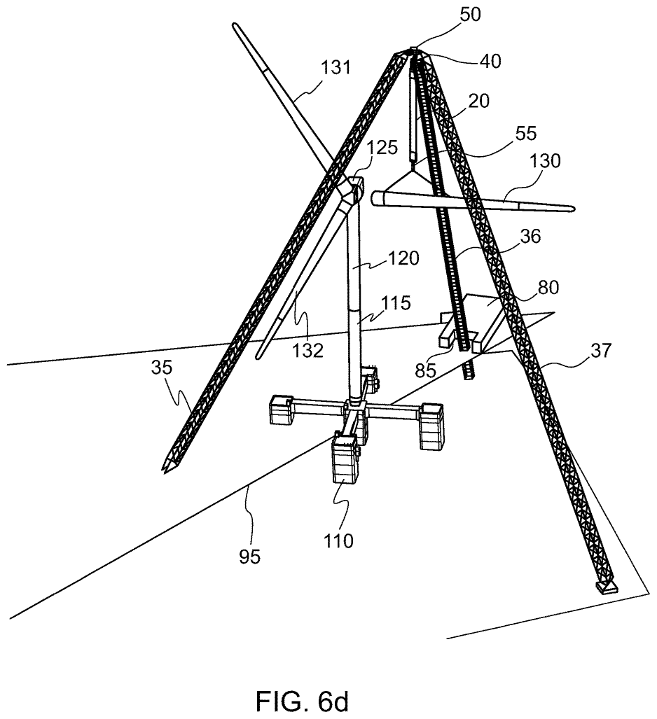

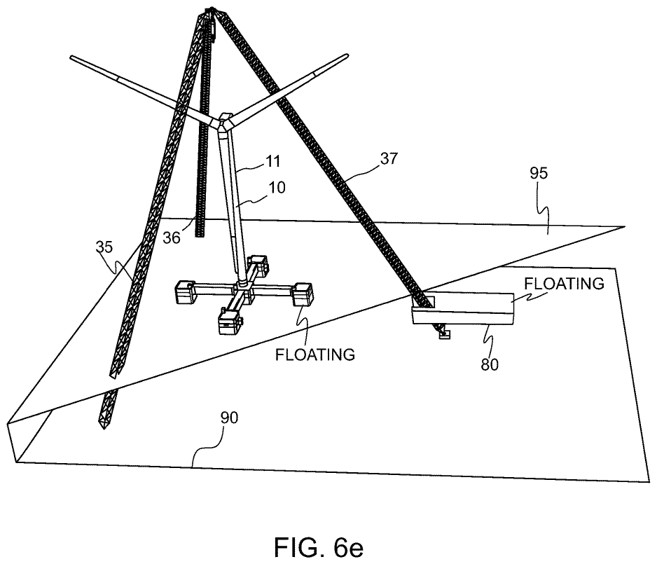

Referring initially to FIGS. 1 to 6(e), there is shown a device/apparatus, generally designated 5, according to a first embodiment of the present disclosure. The device/apparatus 5 is adapted for assembling an offshore structure 10 (see FIGS. 4 and 6(e)) such as a wind turbine or (offshore) wind turbine (generator).

In this embodiment the device/apparatus 5 is used in assembling the structure 10 which is an offshore wind turbine. It will, however, be appreciated that the structure may be another offshore structure, e.g., an offshore jacket. The device/apparatus 5 comprises an (vertically) erectable structure 15 and a lifting arrangement 20.

The device/apparatus 5 comprises or provides an assembly area 25, e.g., on a surface of an area of water, below the lifting arrangement 20, e.g., when erected. Alternatively, the assembly area can be on a surface of an area of land/ground, e.g., a quayside. The assembly area 25 is provided within a perimeter, area or volume of the device/apparatus 5. The lifting arrangement 20 is provided above the assembly area 25, an beneficially directly above the assembly area 25.

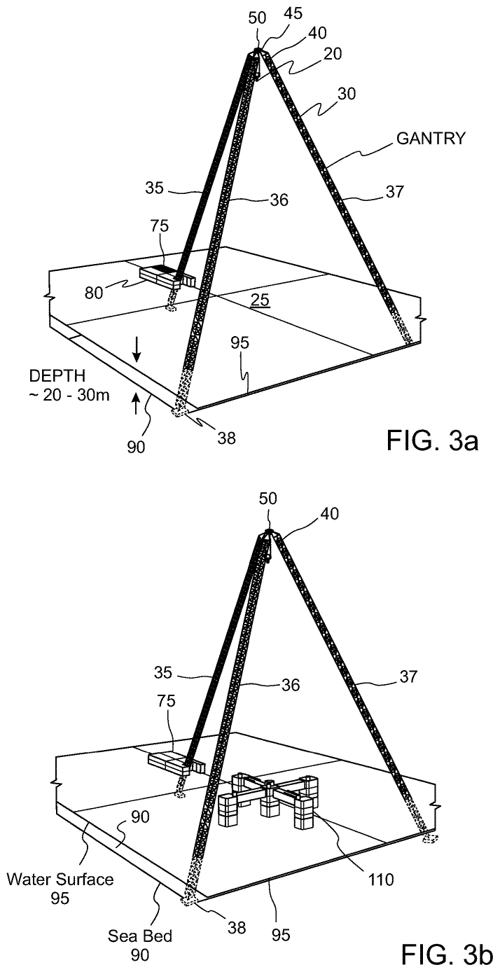

The erectable structure 15 is disposable in a first or collapsed state (see FIG. 1). The first state facilitates moving or transport of the device/apparatus 5. The erectable structure 15 is disposable in a second or expanded or erected state ((see FIG. 3(a) to 6(e)). The erectable structure 15 is expandable or selectively movable from a/the first state to a/the second state. The erectable structure 15 is collapsible or further selectively movable from a/the second state to a/the first state. This selective disposition facilitates the erectable structure 15 being transported in a collapsed state to a location for assembling the structure 10, i.e., to the assembly area, and then when at the location being expanded and erected. Further, this selective disposition may facilitate the erectable being collapsed and/or removed from the assembly area 25 after the structure 10 has been assembled.

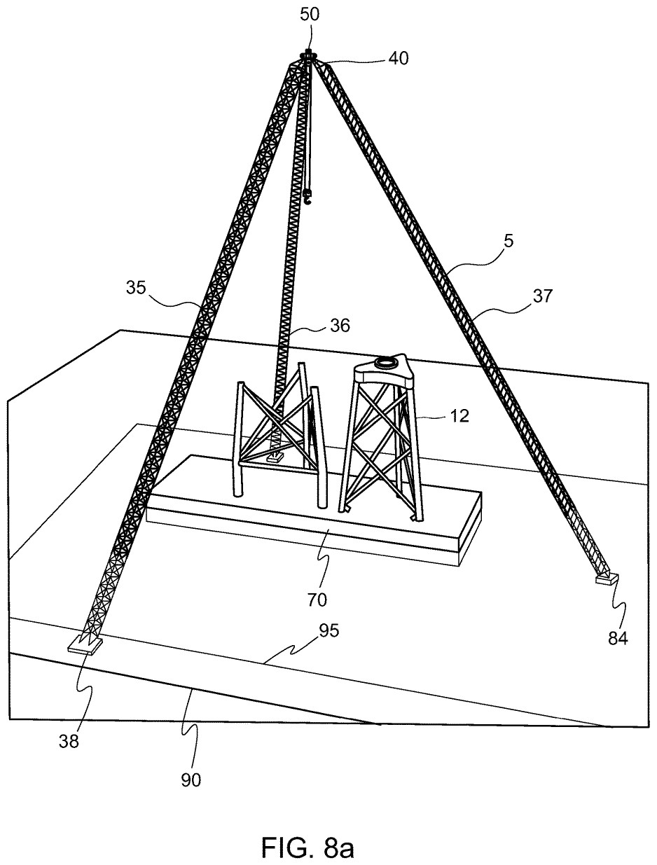

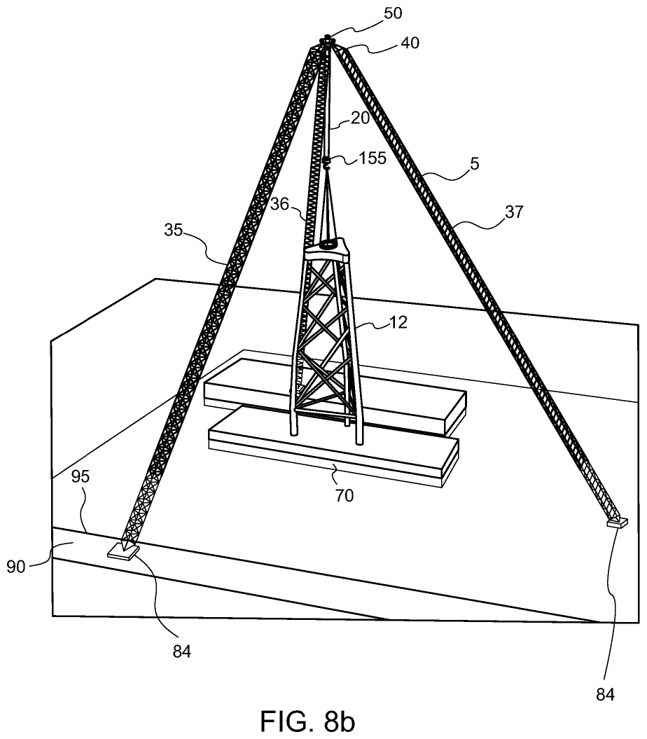

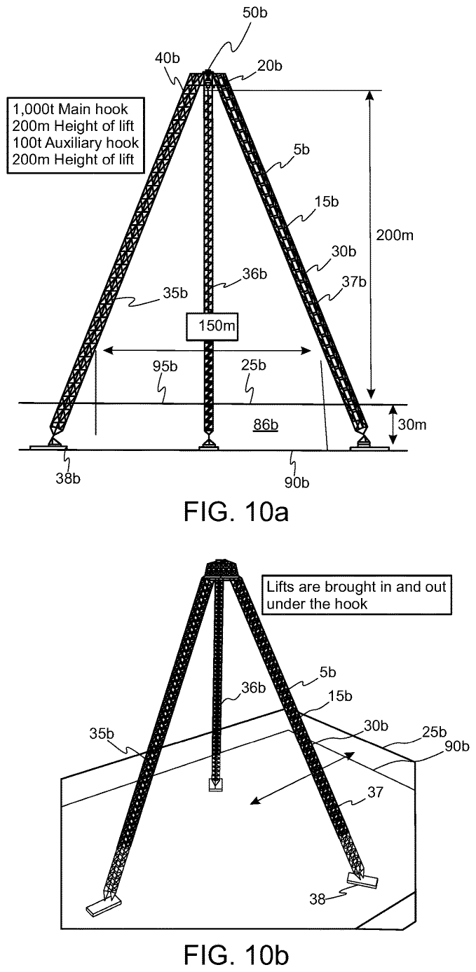

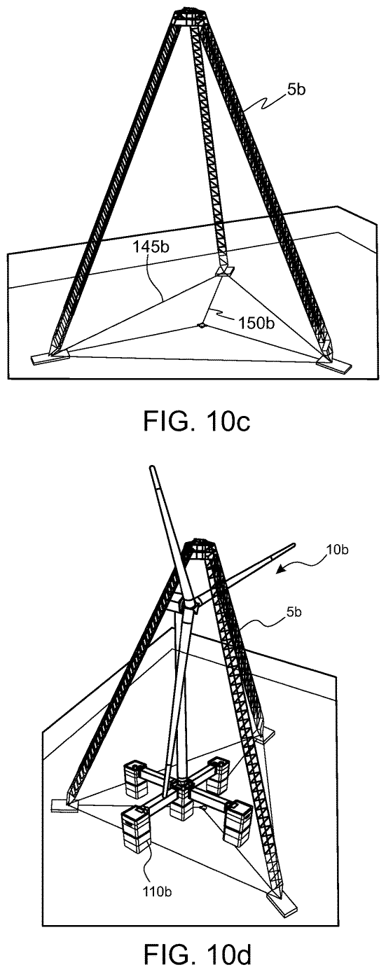

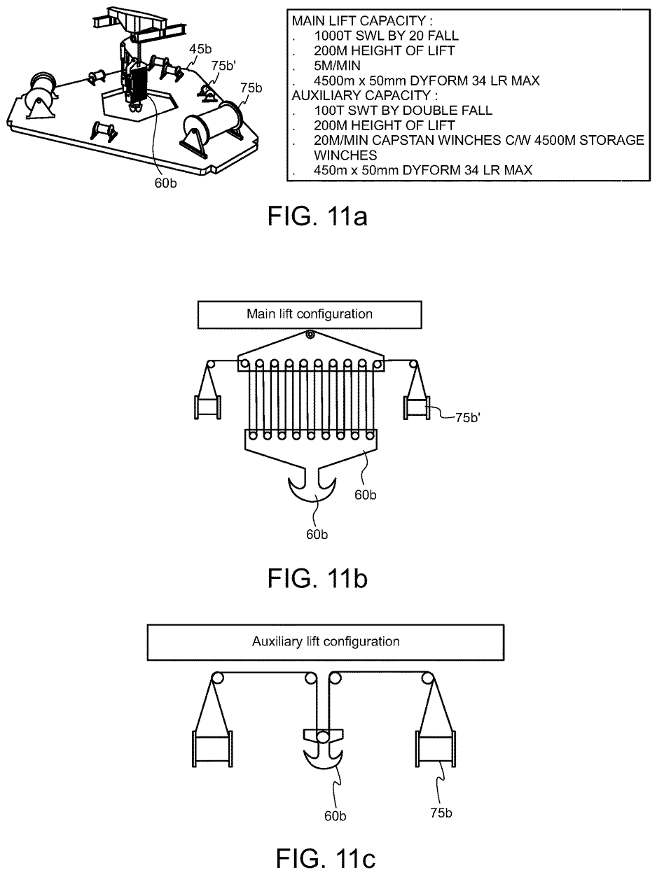

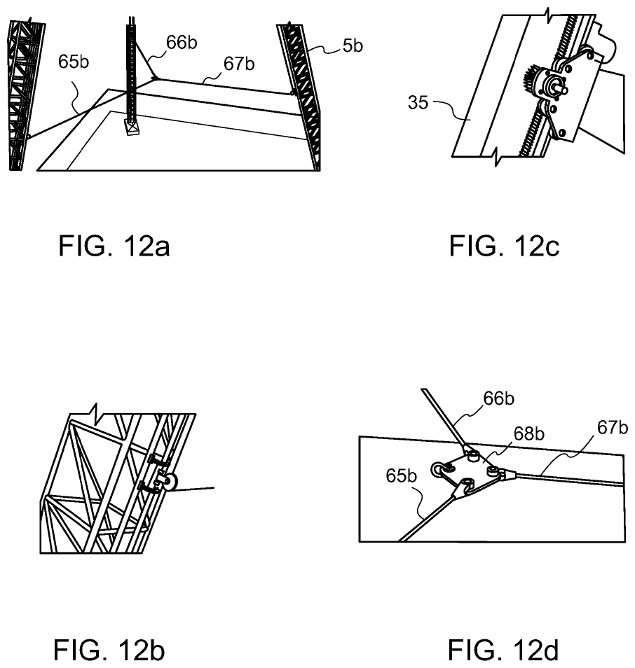

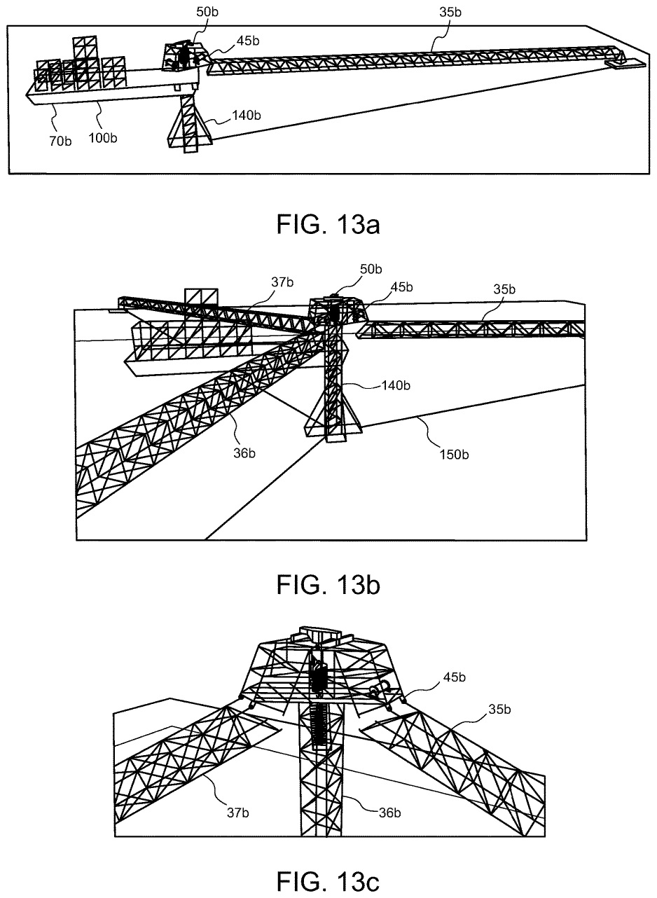

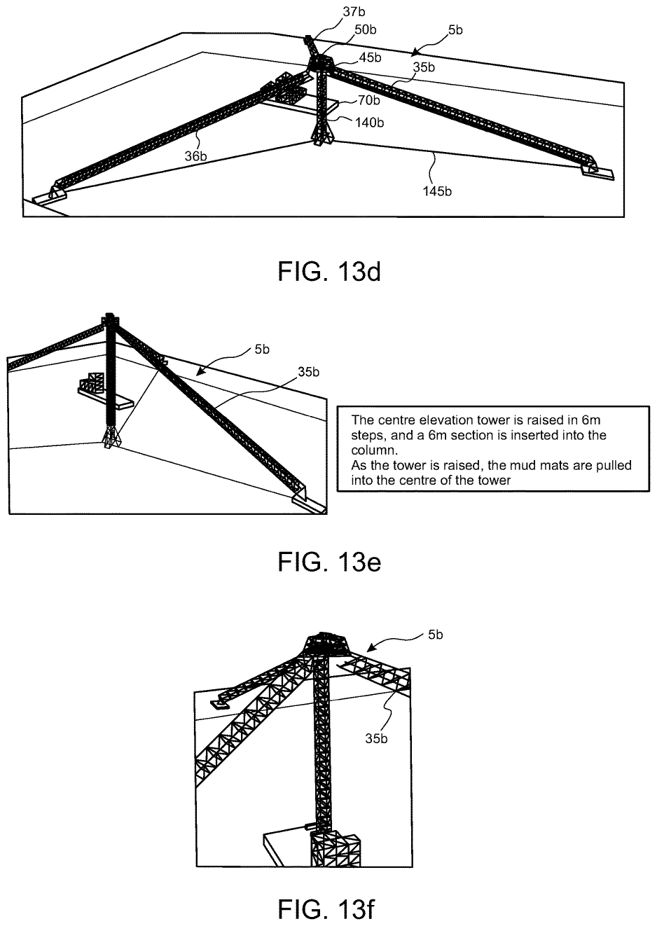

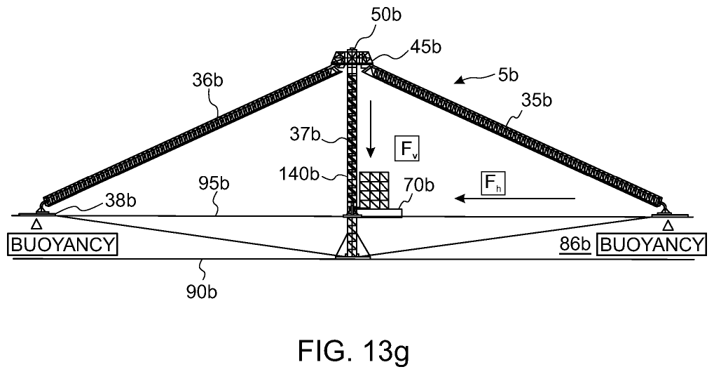

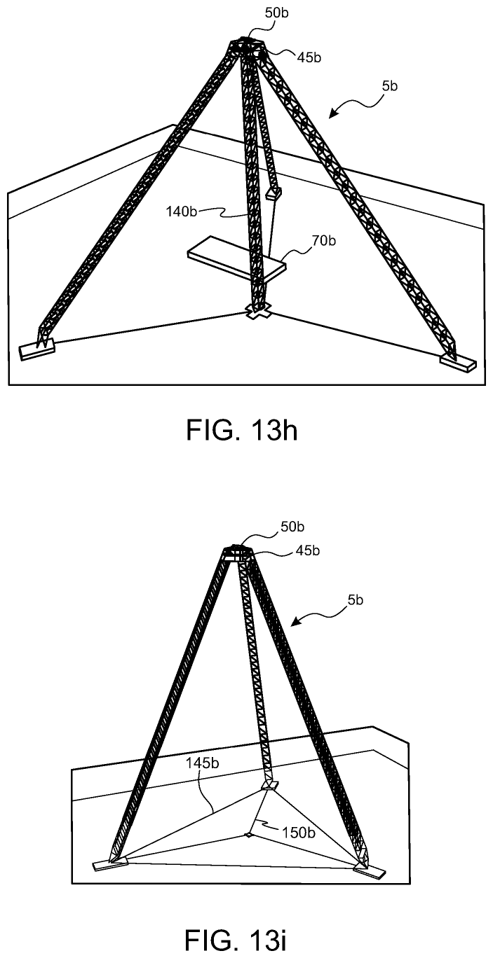

In another embodiment (see FIG. 8(a) to 13(i)), the structure can be capable of being assembled and/or erected at site or in situ. This embodiment facilitates parts of the structure being transported to site individually or at least not assembled for assembly on site.

The structure 15 comprise a plurality of legs 35, 36, 37 and/or an apex (member) 50. The legs 35, 36, 37 are connected to or connectable to the apex (member) 50.

The lifting arrangement 20 is, in use, provided below, e.g., directly below the apex (member) 50.

In this preferred embodiment, the device/apparatus 5 comprises a tripod 30 or tripod arrangement. Alternatively, the device/apparatus 5 can comprise a tetrapod. The tripod 30 comprises three legs 35, 36, 37. Each of the three legs 35, 36, 37 is attached, e.g., hingably attached, at a first end 40 to a connection member 45. The connection member 45 comprises an apex 50 of the tripod 30. The lifting arrangement 20 is attached to and/or, in use, depends (vertically downwardly) from the connection member 45 or apex 50. In this manner, the lifting arrangement 20 is provided between the three legs 35, 36, 37. Each leg 35, 36, 37 is provided at a second end with a mud mat 38. The/each mud mat 38 can be selectively buoyant or submersible.

The lifting arrangement 20 comprises an arrangement 55 for connecting or supporting a part(s) of the offshore structure 10 to be lifted. The connection arrangement 55 comprises one or more hooks, shackles or the like. The lifting arrangement 20, therefore, provides a single point lifting arrangement, e.g., comprising a single lifting point for supporting a load such as a part/component of the structure 10. The lifting arrangement 20 comprises one or more pulley arrangements 60 and/or winches.

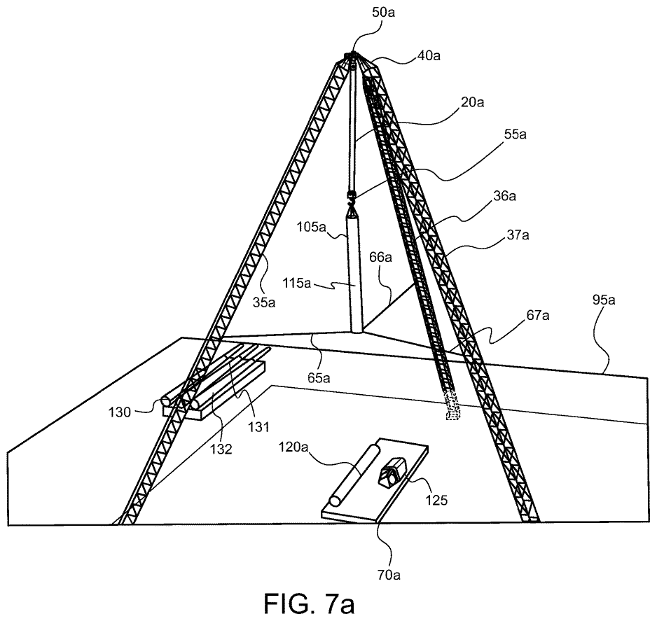

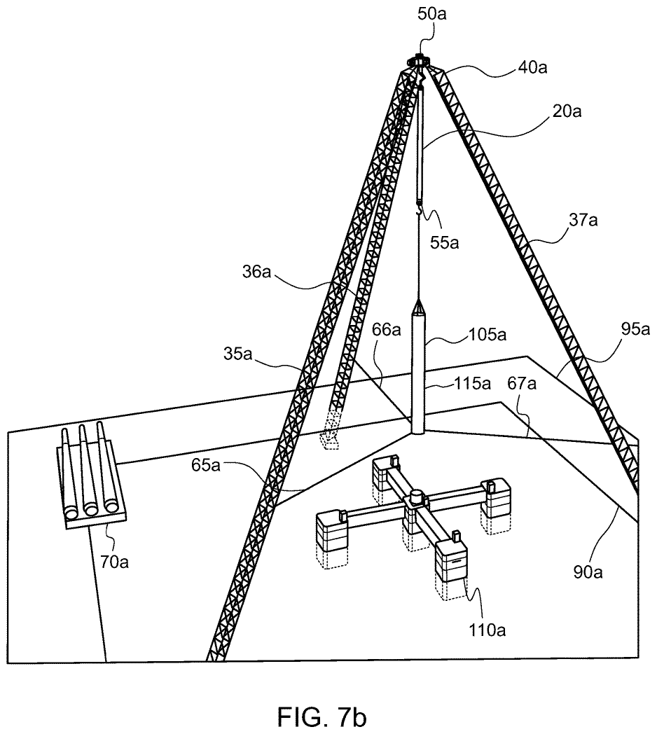

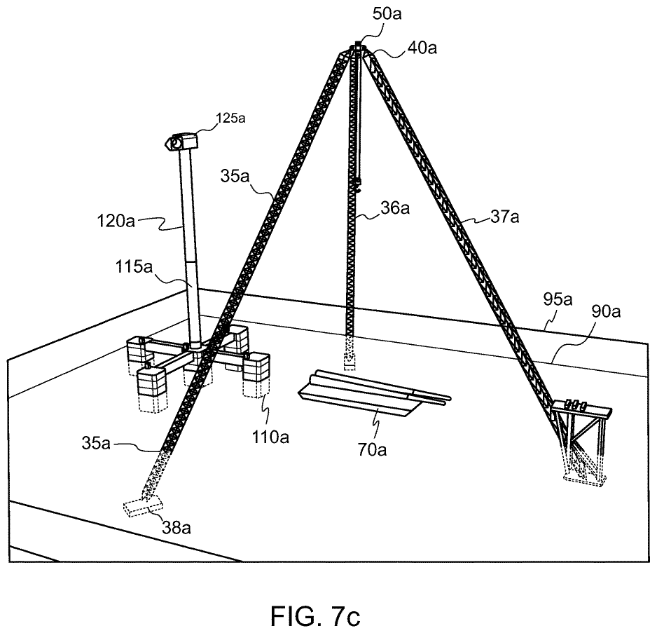

Referring to FIG. 7(a) and (c), there is shown a device/apparatus 5a according to a second embodiment of the present disclosure. The device/apparatus 5a of the second embodiment is similar to the device/apparatus 5 of the first embodiment, like parts be identified by like numerals but suffixed “a”.

In the device/apparatus 5a, one or more lines 65a, 66a, 67a (control/mooring/tagging lines) are provided between at least one and preferably each of the legs 35a, 36a, 37a, the lines being adapted to be connected to a load (e.g., part of the structure) being lifted by the lifting arrangement.

Referring to FIG. 8(a) and (b), there is shown a device/apparatus 5 according to the first embodiment of the present disclosure. In this example, the device/apparatus is used to assemble an offshore jacket 12.

In both the first and second embodiments, the legs 35, 36, 37; 35a, 36a, 37a of the device/apparatus 5; 5a comprise a (metal) lattice arrangement.

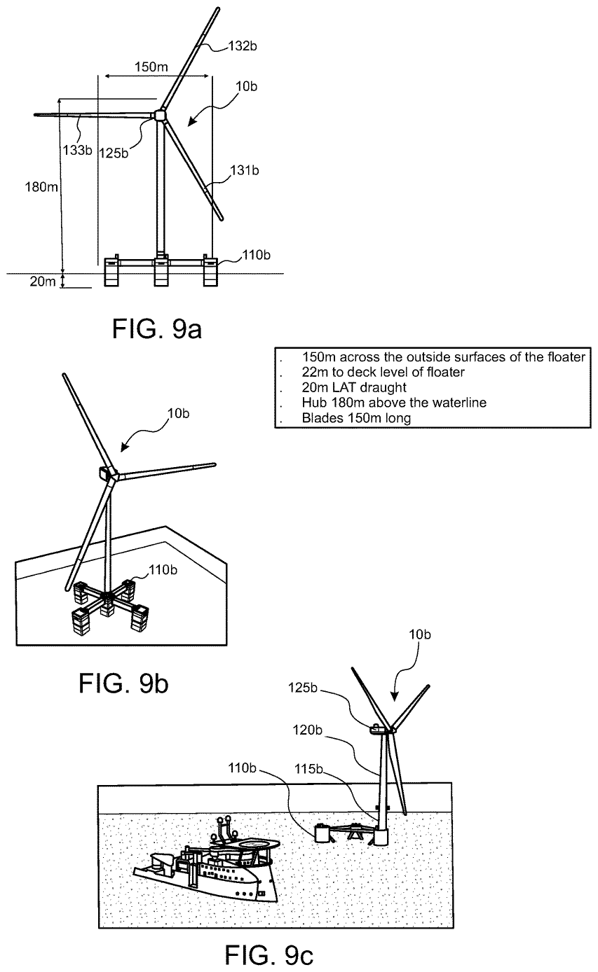

Referring now to FIG. 9(a) to 13(i), there is shown a device/apparatus 5b according to a third embodiment of the present disclosure. The device/apparatus 5b of the third embodiment is similar to the device/apparatus 5 of the first embodiment, like parts being identified by like numeral but suffixed “b”.

In the device/apparatus 5b, the components of the device/apparatus are assembled at site, i.e., at the assembly area 25b.

A connection piece 68b is provided at an intersection of the lines 65a, 66b, 67b.

At or near ends of the legs 35b, 36b, 37b distal the apex 50b, there are provided further lines or cables 145b extending peripherally between adjacent legs 35b, 36b, 37b.

Yet further lines 150 are provided at or near end of each leg 35b, 36b, 37b, which further lines 35b, 36b, 37b extend (horizontally) so as to meet at a (base) centre point of the device/apparatus 5b, e.g., below the apex 50b.

In this embodiment auxiliary winches 75′b are provided.

The present disclosure provides a system for assembling an offshore structure (such as wind turbine or jacket, such as an offshore structure, wind turbine or jacket), the system comprising a device/apparatus 5; 5a; 5b.

The system comprises a floating or buoyant body/bodies 70 for transporting one or more parts of the offshore structure to the assembly area 25.

The system comprises one or more winches 75, e.g., for controlling the lifting arrangement.

The one or more winches 75 can be provided on a further floating or buoyant body 80. The further floating or buoyant body 80 is adapted to be secured to a leg 35 of the device/apparatus 5. For example, the further floating or buoyant body 80 comprises a slotted or recessed portion 85 for engagement with a leg 35 of the device/apparatus 5. The slotted portion 85 can also receive the connection member during transportation of the device/apparatus when in a collapsed state.

The present disclosure provides a method of deploying a device/apparatus 5; 5a; 5b for assembling an (offshore) structure 10, such as a wind turbine, such as an (floating/buoyant) offshore structure, wind turbine or jacket. The method comprises:
providing at or to an assembly area 25 or location a device/apparatus 5; 5a; 5b and
deploying/erecting the device/apparatus 5; 5a.

In the disclosed embodiments the assembly area 25; 25a; 25b or location is an area of water. Also, in the disclosed embodiments, the device/apparatus 5; 5a; 5b when erected stands/sits on a bed of a body of water 86, e.g., a seabed 90. Also, the apex 50 and the lifting arrangement 20 are provided above a surface level 95 of the body of water 86.

The step of providing the device/apparatus 5; 5a; 5b to the assembly area 25; 25a; 25b comprises use of one or more vessels or barges 100.

The present disclosure provides a method of assembling a structure or wind turbine, such as an offshore structure 10, wind turbine or jacket. The method comprises:
deploying the device/apparatus 5; 5a; 5b according to the aforementioned method;
transporting a first part 105 of the offshore structure 10 to the assembly area;
lifting the first part 105 using the lifting arrangement 20;
transporting a floating/buoyant base or foundation body 110 to the assembly area 25;
connecting/clamping the first part 105 of the structure 10 to the floating/buoyant base body.

The method may comprise the subsequent step(s) of transporting a further part of the structure 10 to the assembly area 25;
lifting the further part using the lifting arrangement 20;
transporting the floating/buoyant base body to the assembly area 25;
lowering and/or connecting the further part of the structure to the first/a part of the structure already provided on the floating/buoyant base body 110.

The structure 10 (including the floating base body 110) is a floating structure.

The structure 10 comprises or includes:
a plurality of parts or components;
a segmented (offshore) structure;
a floating/buoyant foundation;
a monopile;
a wind turbine (see FIGS. 4 and 6(a) to 6(e) or FIGS.(a) to 7(c));
a jacket (see FIG. 8(a) and (b)), e.g., a three-leg jacket, a four-leg jacket or a twisted jacket.
In the case of the structure 10 comprising a wind turbine, the parts comprise one or more of:
column or tower, e.g., first and second column parts 115, 120 (e.g., around 400-500 tonnes each);
a nacelle 125 (e.g., around 60 tonnes);
a plurality of turbine blades, e.g., three turbine blades 130, 131, 132 (e.g., around 60 tonnes each).

In such case, there are a given number of parts (six) and so a requirement for a same given number of lifts (six).

In the embodiment shown in FIG. 9(a) to 13(i), the method comprises using a tower 140, post or column for supporting (parts of) the structure during assembly.

There is provided an arrangement for extending or increasing a height of the tower 140, post or column, in use, e.g., in intervals, so as to lift the structure 10b and/or apex 50b of the structure 10b, e.g., the tower may be telescopic.

Typically, blades 130, 131, 122 will be lifted horizontally.

According to the present disclosure there is provided a method of assembling an (offshore) structure 10, such as an (offshore) wind turbine or (offshore) jacket. The method comprises the steps of:
providing a lifting arrangement 20 comprising:
   a gantry disposed over and/or directly above an area of water; and
   a lifting means or apparatus coupled to the gantry; and stacking portions of the structure 10 by:
   conveyably disposing a first portion of the structure 10 relative to or at the area of water:
   lifting the first portion using the lifting means;
   configuring a clamping or retaining device 135 to grip the first portion; and
   conveying the clamping or retaining device away from the area of water;
   lifting a second portion of the structure 10 using the lifting means or apparatus;
   disposing the first portion underneath or adjacent the second portion by further conveying the first portion gripped by the clamping device 135 to the area of water; and
   lowering the second portion onto or so as to connect with the first portion.

The step of lifting the second portion using the lifting means or apparatus comprises hoisting and/or raising the second portion in an upwards direction to a height above an uppermost level of first portion.

The method comprises a step of fixedly coupling the second portion to the first portion by bolting, welding, and/or clamping.

The structure 10 can be a wind turbine assembly, such as an offshore wind turbine, or a jacket, such as an offshore jacket, e.g., for supporting a wind turbine.

The first portion and/or the second portion and/or one or more further portion(s) can be at least one of: a portion of a tower or a nacelle or a turbine blade(s).

The method further comprises the step of stacking a/the further portion on the second portion by:
lifting the further portion using the lifting means;
disposing the second portion of the structure underneath the further portion by conveying the second portion to the area of water;
lowering the further portion onto the second portion.

The clamping device may be provided on a floating or buoyant body, e.g., a floating foundation or (top) crown assembly.

The clamp 135 or clamping device is configured for supporting and/or clamping and/or gripping at least a portion of the structure 10 in a vertical disposition and/or substantially upright configuration.

The present disclosure provides a system for assembling a structure 10, such as an (offshore) wind turbine or (offshore) jacket. The system comprises:
a gantry disposed over and/or directly above an area of water;
lifting means coupled to the gantry; and
means for conveying a portion of the structure 10 to and from the area of water, wherein
the means for conveying a portion of the structure comprises a clamping or retaining device 135.

The clamping or retaining device 135 is configurable between a clamping or retention configuration for gripping a portion of the structure 10 and a non-clamping or non-retention configuration.

The clamping device 135 is coupled to or mounted on a floating or buoyant base body 110, e.g., a floating foundation or (top) crown assembly or barge.

The lifting means comprise a winch(es) 75 and/or a pulley or pulley arrangement 60.

The system is adapted for assembling a wind turbine assembly or a jacket, such as an offshore wind turbine assembly or an offshore jacket assembly, e.g., for a wind turbine.

The system comprises a clamping and/or gripping system comprising:
the clamping device 135 for gripping at least a portion of a wind turbine assembly; and
a/the floating or buoyant base body 110,
wherein the clamping device is mounted on the floating or buoyant base body 110.

The clamping device 135 is configured for supporting at least a portion of a wind turbine assembly or jacket assembly in a vertical disposition and/or substantially upright configuration.

The clamping device 135 is configured to engage with a flange or rim disposed on an outer surface of the portion of the structure 10.

Referring now to FIG. 14, there is shown a device/apparatus 5c according to a fourth embodiment of the present disclosure. The device/apparatus 5c of the fourth embodiment is similar to the device/apparatus 5 of the first embodiment, like parts being identified by like numeral but suffixed “b”.

In the device/apparatus 5c of the fourth embodiment each leg 35c, 36c, 37c is provided with a support member 38. The three support members 38 are provided at or near a respective end of the leg 35c, 36c, 37c distal the apex 50c. Each support member 38 is deployed in a substantially vertical disposition, in use. The support member imparts support/strength to the respective leg 35c, 36c, 37c so as to seek to avoid buckling of the leg 35c, 36c, 37c.

With regard to various embodiments of the present disclosure, the reader will note the following:
1. The system creates a single point sufficiently high to lift the nacelle 125 onto the top of the column of a floating wind turbine. This is anticipated to be around 220 m above sea level.
2. The single point lift may have multiple hooks with different capacities-for instance 1,000 tons and 120 tons. These would be suspended from the same location under the lifting point on possibly a tri-plate arrangement.
3. The system is planned to be supported on (moored to) the seabed.
4. The system is planned to be in water deep enough for the floating turbine support structure to be located in a floating condition with the turbine location directly below the hook.
5. The structure supporting the hook may be self-erecting.
6. The components can be brought under the hook using floating transportation barges or ships.
7. The sea-transportation is planned to be moored such that it can be moved under the hook and then away to a storage location without disconnecting the moorings. The position would be moved by winches adjusting the lengths of mooring lines.
8. The floating structure would similarly be moored and moved under the hook for installation of the wind turbine components.
9. The wind turbine components would be lifted higher than their location on the floating structure, and when the structure is located under the hook the component would be lowered into place on the floating structure.
10. The support structure may be achieved by one of the following methods:
   a. A tripod structure with pads supporting it on the seabed
   b. Two piled towers (similar to wind turbine towers) with a beam at the top spanning between the towers with the hook(s) suspended from the beam. The towers may be angled so that the spacing at the base is greater than at the top as the floating structure is wider at the base than at the top. This reduces the size of beam at the top. The support piles may also be angled so that there is limited bending moment in the towers (axial compressive force).
   c. The towers could be lattice structures.
   d. The towers could be dismantlable for ease of transportation
11. The system will also be used for installing the blades. This is one of the reasons for the smaller hook.
12. The winches for the hooks would be in the base of the towers above the water line. The power for the winches may be on the towers or from another vessel or power supply.
13. The winches would most likely be multi-fall. It may be two winches with a common wire allowing the work points of the wire to be adjusted to increase its life. The winches could be in separate legs.
14. The hooks may have some local later movement.
15. The hooks will have swivels which may be powered.
16. There will be various access platforms which will allow access to the various components as necessary for carrying out the assembly tasks. These may be retractable platforms with the ability to extend, slew and vary in height from their foundation point on the tower.
17. The towers may float when on the sea-there may be fixed tanks in the towers.
18. There will be personnel transport systems (lifts) and equipment transport system inside or outside at least one of the legs.

With regard to embodiments where the structure 10 is a jacket, e.g., for a wind turbine, the reader will note the following.

Sometimes support jackets for offshore wind turbines are made in two halves (upper and lower) and joined together before going offshore. The single point lift could be used for that purpose. In such case, the reader will note:
1. Jackets are attached (moored) to the seabed.
2. The jackets could come to the assembly site in two halves onboard a barge/ship.
3. The floating transport would locate under the lifting point and attach to the upper part of the jacket.
4. The upper part of the jacket would be lifted and suspended higher than the lower part of the jacket.
5. The floating transport would be moved to bring the lower part of the jacket under the upper part.
6. The upper part would be lowered and landed on the lower part of the jacket.
7. The permanent connection between the upper and lower part would be completed.

This may be of particular benefit in locations having a lot of bridges at the entrances to ports or the like.

In addition to the attributes previously discussed, notable features of the present disclosure are as follows:
Single point lift, optionally with possible micro movement (500 mm).
Could be from:
gantry (fixed to the seabed), and which may taper towards the top
3 leg tripod or 4 leg tetrapod, which could have equal leg sizes and so also equal angles or different sized legs/angles.
Because the lifting point is static, the build-up of the wind turbine tower (onto a floating foundation) or jacket (onto a barge or similar) is via moving the ‘floater’ or barge and tower/jacket components in and out under the single point lift. This could be via winches or vessels (tugs)-winches preferred to keep vessels away from the lifting structure.
Erection of the tripod/tetrapod could be through pushing from below/lifting from above the centre tri-plate along with also possibly tightening the connections between the legs.
Tripod/tetrapod could be assembled at the quayside or on quay and towed to site or towed to site and assembled in parts.
The tripod/tetrapod may have buoyancy fitted around the structure (or as part of the structure itself) to assist with erection, e.g., may be part assembled under water.
Tripod/tetrapod could be mobile and transportable.
The device/apparatus could be used for construction and/or subsequent maintenance.
The device/apparatus could be used onshore (though the Inventors expect that the max. benefits will be derived from use offshore in an area with sufficient water depth, sufficiently deep access channel, reasonably sheltered, near a workforce and near marshalling and support port facilities).

It will be appreciated that the embodiments of the present disclosure hereinbefore described are given by way of example only and are not meant to limit the scope of thereof in any way.

It will be appreciated that in preferred embodiments of the present disclosure, the structure is a floating/buoyant structure and/or is provided on a floating/buoyant (base) body or foundation.

It will be appreciated that the device/apparatus of embodiments of the present disclosure allows for:
unattended lifting of parts of the structure;
landing of parts of the structure without human intervention within the assembly area;
no personnel being required to be deployed under the lifting arrangement, in use.

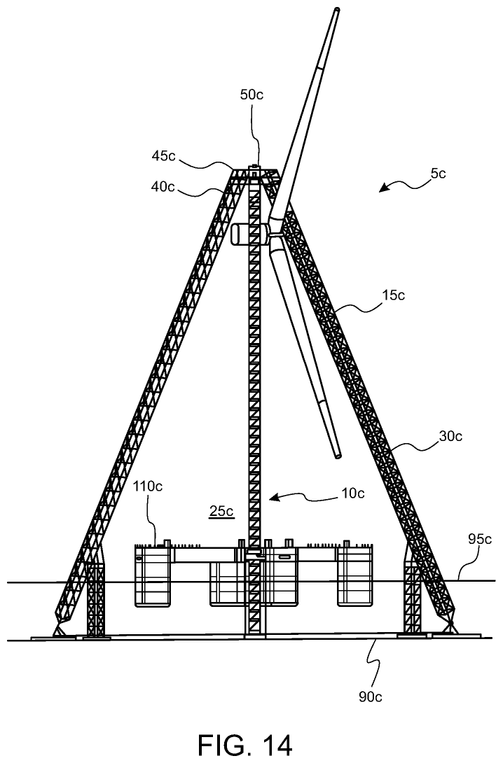

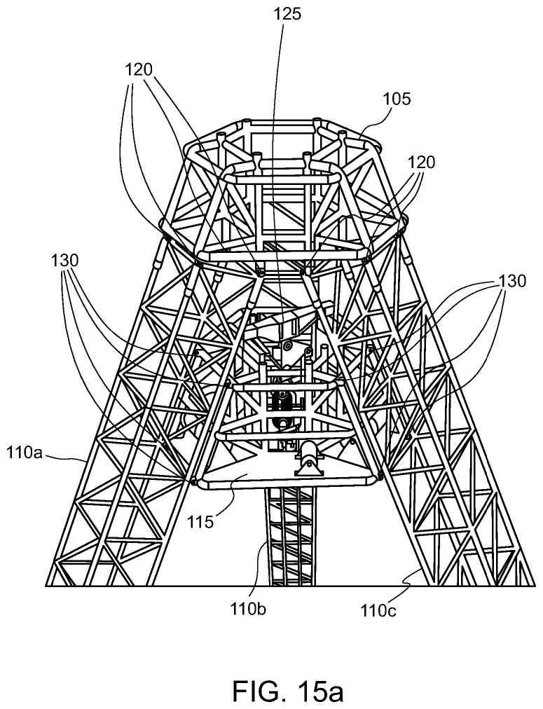

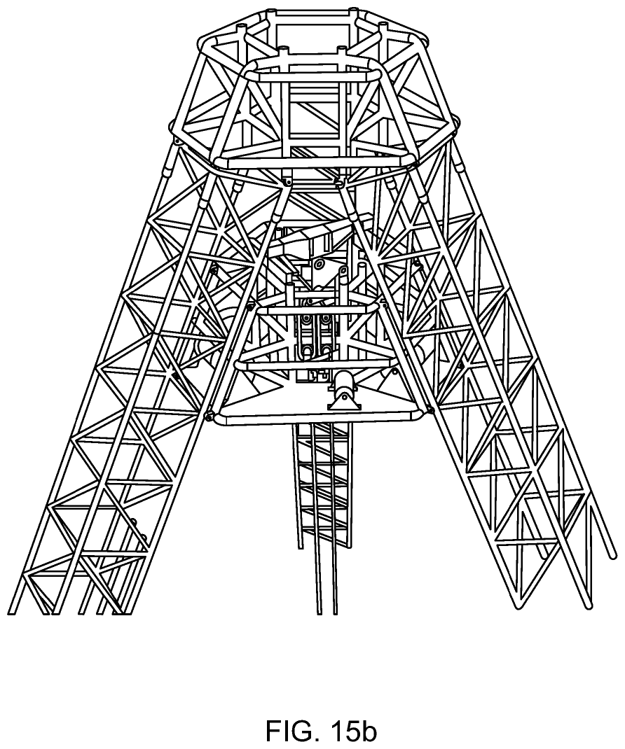

FIG. 15a depicts a perspective view of a running gear module, according to an embodiment of the disclosure. FIG. 15b depicts a line drawing of the running gear module of FIG. 15a. The layout in effect has two top assemblies: the top holds the three legs together and supports the running gear module which can be run up and down the structure, e.g. such as the post or column, such as the tower 140. In an example, a weight of the running gear may be in the region of 250t, but the load it can generate may be the full capacity of the multi fall hook. In example embodiments, 1000t, 1500t or even greater lift may be provisioned for.

A top assembly 105 is shown. The top assembly 105 may be a central portion. Also depicted are three legs 110a, 110b, 110c of the erectable structure.

The top assembly 105 holds the three legs 110a, 110b, 110c together and supports a running gear module 115 which can be run up and down the structure, e.g. run up and down the post or column, such as the tower 140.

A first plurality of pin and clevis arrangements 120 are depicted. The pin and clevis arrangements 120 couple the top assembly 105 to the three legs 110a, 110b, 110c

Also depicted is a hoist 125 to pull up the running gear module 115. In a non-limiting example, the hoist may have a 300t capacity.

When fully in position, as depicted, a second plurality of pin and clevis arrangements 130 may fix the running gear module 115 to the structure, e.g. to the three legs 110a, 110b, 110c, thereby providing a mechanical connection.

With general reference to the above-described embodiments, and in particular the example embodiments of FIGS. 15a and 15b:
1. The erection of the tripod (or multi legged structure) may be assisted by a post mounted on a floating structure which is through the central part of the ‘tripod’. The central part of the structure may then be ‘walked’ up the post with for instance a walking clamp or clamps while simultaneously pulling on tension members between the centre and the base (or towards the base) of the legs or between the bases of the legs. The post may be initially on a floating structure with the top of the multi-leg structure placed around the post (it may be installed in pieces that are then joined together on the deck or it may be lowered over the top of the post. The floating structure may be lowered to the seabed to provide the reaction to lift the multi-legged structure into position or it may be floating providing there is sufficient buoyancy and stability capacity to react the loads. The post may alternatively be fitted with linear winches at the top to lift the top of the multi-legged structure or may have return sheaves with winches on the deck. The post may have another post inside so that when the top of the multi-legged structure reaches the top of the post then the internal post may be extended to continue with the raising process.
2. The multi leg structure may be erected without any of the lifting machinery in place. It may then be lifted into place following erection of the structure.
3. The structure may have some of it key structural components lifted into place following the initial erection of the structure. These structural components may also form part of the platform for the lifting machinery.
4. The lifting machinery may be able to be lowered and taken away for any reason including but not exclusively servicing, maintenance, repair, preservation.
5. The windage of the structure may be reduced by removing some of the structure-particularly upper structure-for instance roofs or safe areas for personnel that may only be required during operations.
6. The parts of the structure that are lifted post the initial erection may be used to make the structure stiffer in order to reduce buckling loads.
7. In the case of a tripod it is envisaged that there may be a mud-mat barge at the base of each leg. These barges could be fitted with buoyancy that may extend from their deck and when on the seabed their tops would be above the waterline.
8. This may assist with the sinking of the mud-mat barges into place.

The mud-mat barges may be ballasted so that they provide lateral stability (from say wind and tidal forces) during their operations. This may be achieved by at least one of:
a. Pumping in water or other higher density material to provide a gravity anchor (e.g. mud or haematite)
b. Sheet piles around the mud-mat barge
c. Piled anchors
d. Suction anchors
e. Dray anchors attached by chain, wire or rope
f. Securing lines to the shore.

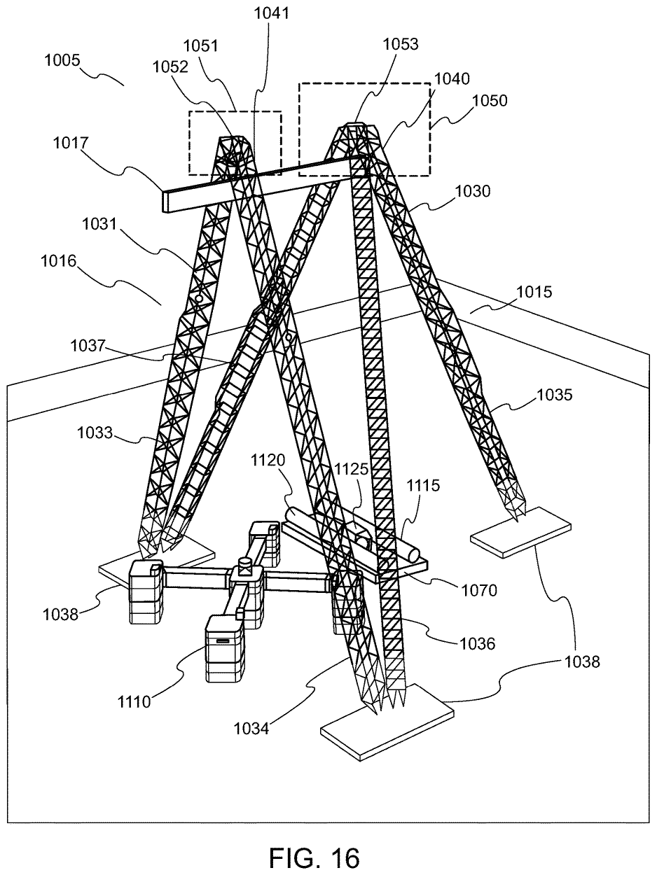

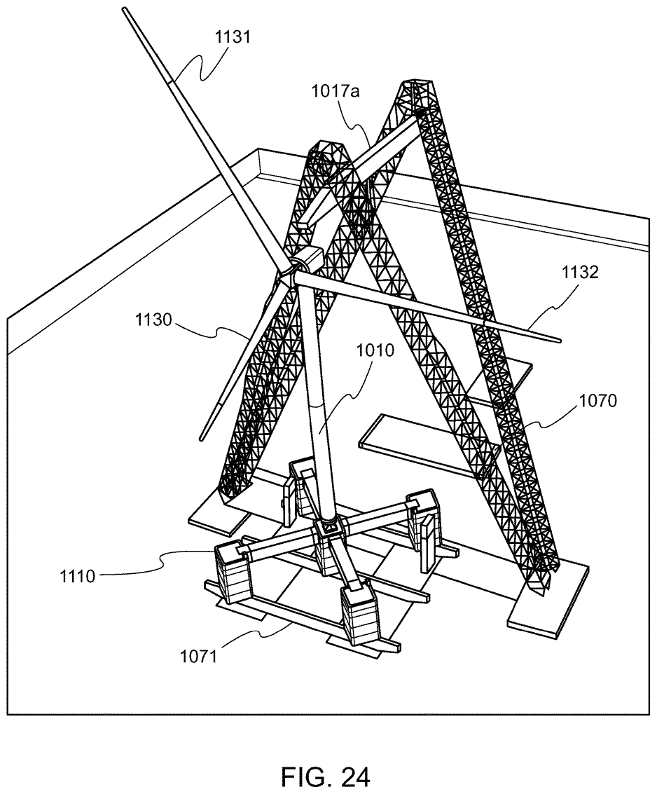

Referring now to FIG. 16, there is depicted an apparatus, generally designated 1005. The apparatus 1005 is adapted for assembling an offshore structure 1010 (see FIG. 24) such as a wind turbine or (offshore) wind turbine (generator).

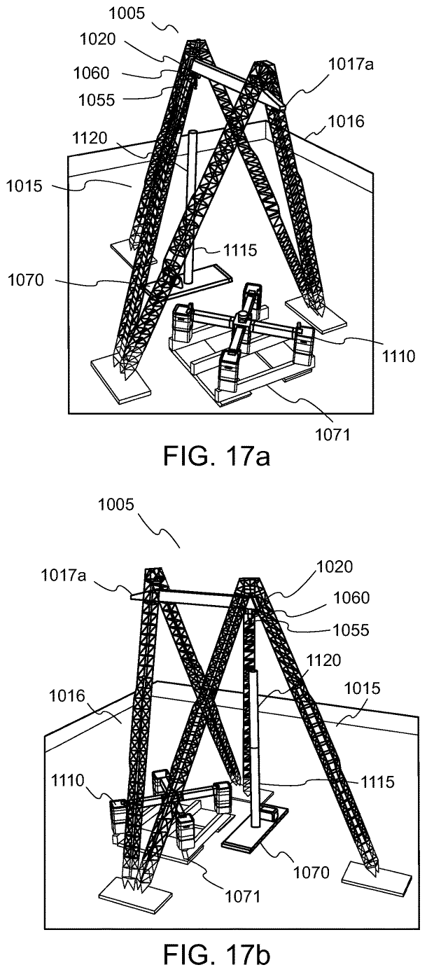

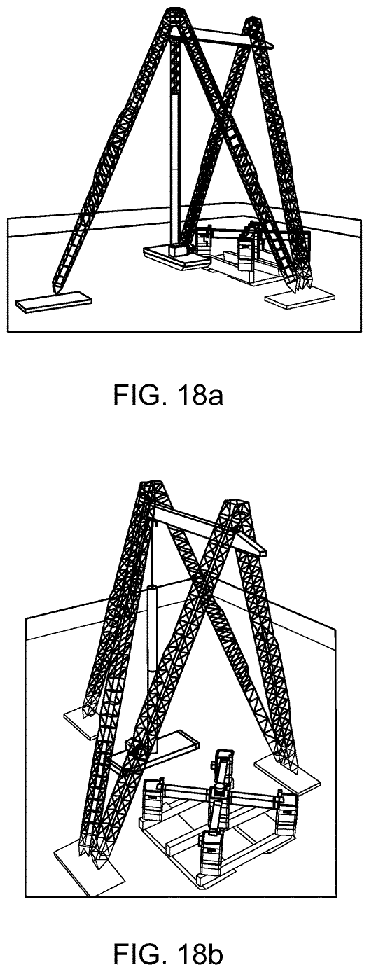

In this embodiment, the apparatus 1005 is used in assembling the structure which is an offshore wind turbine. It will, however, be appreciated that the structure may be another offshore structure, e.g., an offshore jacket. The apparatus comprises first and second (vertically or substantially vertically) erectable structures 1015, 1016, an elongate structure 1017 and a lifting arrangement 1020 (see FIGS. 17a to 18b).

When erected the device/apparatus 1005 defines an assembly area, e.g., an area of water, e.g., above a bed or floor of a body of water, e.g., a seabed, below the lifting arrangement 1020. Alternatively, the assembly area can be on a surface of an area of land/ground, e.g., a quayside. The assembly area may be provided below, e.g., directly below, the lifting arrangement 1020, e.g., when erected.

The assembly area is provided within a perimeter, area or volume of the apparatus 1005. The lifting arrangement 1020 is provided above the assembly area, and beneficially directly above the assembly area.

The first and second erectable structures 1015, 1016 are disposable in a first or collapsed state. For example, FIG. 1 depicts a structure corresponding to the first erectable structure 1015 in the collapsed state. The first state facilitates moving or transport of the apparatus 1005. The first and second erectable structures 1015, 1016 are disposable in a second or expanded or erected state (see FIGS. 16 to 18(b)). The erectable structure 1015 is expandable or selectively movable from the first state to the second state. The first and second erectable structures 1015, 1016 are collapsible or further selectively movable from a/the second state to a/the first state. This selective disposition facilitates the first and second erectable structures 1015, 1016 being transported in a collapsed state to a location for assembling the structure 1010, i.e., to an assembly site, and then when at the location being expanded and erected. Further, this selective disposition may facilitate the first and second erectable structures 1015, 1016 being collapsed and/or removed from the assembly site after the structure 1010 has been assembled.

The first and/or second erectable structure 1015, 1016 may be similar to the erectable structure 15 of the first embodiment of the present disclosure. The first structure 1015 comprises a first plurality of legs 1035, 1036, 1037 and/or a first connection arrangement 1050. The legs 1035, 1036, 1037 are connected to or connectable by the first connection arrangement 1050. The second structure 1016 comprises a second plurality of legs 1033, 1034 and/or a second connection arrangement 1051. The legs 1033, 1034 are connected to or connectable by the second connection arrangement 1051.

The first and/or second connection arrangements 1050, 1051 may comprise an apex member such as the apex (member) 50 of the first embodiment of the present disclosure. The apex (member) of the first and second connection arrangements 1050, 1051 may define a first and second apex 1052, 1053 of the first and second plurality of legs respectively.

The elongate structure 1017 extends between, the first and second erectable structures 1015, 1016. The elongate structure 1017 is preferably connected or connectable to the first and second erectable structures 1015, 1016 by the first and second connection arrangements 1050, 1051 respectively, and more preferably extends directly below the first and second connection arrangements 1050, 1051.

In this embodiment, the first erectable structure 1015 comprises a tripod 1030 or tripod arrangement and the second erectable structure 1016 comprises a pair of shear legs 1031. Alternatively, the first erectable structure 1015 may comprise a tetrapod and/or the second erectable structure 1016 may comprise an A-Frame, tripod or tetrapod. The example tripod 1030 comprises three legs 1035, 1036, 1037. Each of the three legs 1035, 1036, 1037 is attached, e.g., hingably attached, at a first end 1040 to the first connection arrangement 1050. The example shear legs 1031 comprise two legs 1033, 1034. Each of the two legs 1033, 1034 is coupled or attached, e.g., hingably of fixedly attached, at a first end 1041 to the second connection arrangement 1051.

Each leg 1033, 1034, 1035, 1036, 1037 is provided at a second end with a mud mat 1038. Alternatively, as shown in this example embodiment one or more legs, e.g. 1034 and 1036 may share a mud mat 1038. The/each mud mat 1038 can be selectively buoyant or submersible. Each leg 1033, 1034, 1035, 1036, 1037 may be hingably coupled to its respective (or shared) mud mat 1038 such that it is configured, or configurable to pivot at the second end relative to its respective mud mat 1038. In this embodiment, the legs 1033, 1034, 1035, 1036, 1037 of the apparatus 1005 comprise a (metal) lattice arrangement.

In this embodiment the legs 1033, 1034, 1035, 1036, 1037 are of fixed length. Alternatively, one or more of the legs 1033, 1034, 1035, 1036, 1037 may be configured to be extendable and/or configured to extend by insertion of an extension portion to the respective leg.

In this example embodiment, the elongate structure 1017 comprises a beam provided with a cantilevered portion which extends from the second erectable structure 1016 in a direction away from the first erectable structure 1015. Alternatively, the elongate structure 1017 may comprise a truss and/or the cantilevered portion may comprise a tapered portion (see elongate structure 1017a in FIG. 17a/b).

Referring now to FIGS. 17a to 18b, there is shown an apparatus 1005 according to the ninth embodiment of the present disclosure. In this example, the lifting arrangement 1020 is used to lift assembled column parts 1115, 1120 of the structure 1010.

The lifting arrangement 1020 is configured/configurable to move a load, e.g., assembled column parts 1115, 1120, along the elongate structure between the first and second erectable structures 1015, 1016. The lifting arrangement 1020 comprises an arrangement 1055 for connecting or supporting a part(s) of the offshore structure 1010 to be lifted. The connection arrangement 1055 comprises one or more hooks, shackles or the like. The lifting arrangement 1020, therefore, provides a single point lifting arrangement, e.g., comprising a single lifting point for supporting a load such as a part/component of the structure 1010, e.g., assembled column parts 1115, 1120.

The lifting arrangement 1020 comprises one or more pulley arrangements 1060 and/or winches.

Referring now to FIGS. 17a to 24 there is provided a system, according to the tenth embodiment of the present disclosure, for assembling a structure such as a wind turbine or jacket, comprising the apparatus 1005 according to the ninth aspect.

The system comprises a first body 1070 for transporting one or more parts of the structure 1010 e.g., assembled column parts 1115, 1120 to the assembly area provided below at least a portion of the lifting arrangement 1020.

In this example embodiment, the first body 1070 is a floating or buoyant body, e.g. one or more barges, vessels or the like. The first body 1070 may be stabilised relative to a bed or floor of a body of water below the lifting arrangement 1020 using a first stabilising arrangement e.g., a jack, mooring or anchor arrangement (not depicted) limiting the movement of the first body 1070 relative to the sea bed or floor.

The system further comprises a second body 1071 for transporting one or more parts of the structure 1010 e.g., floating/buoyant base or foundation body 1110 to the assembly area provided below at least a portion of the lifting arrangement 1020 and/or for assembling the structure 1010 on.

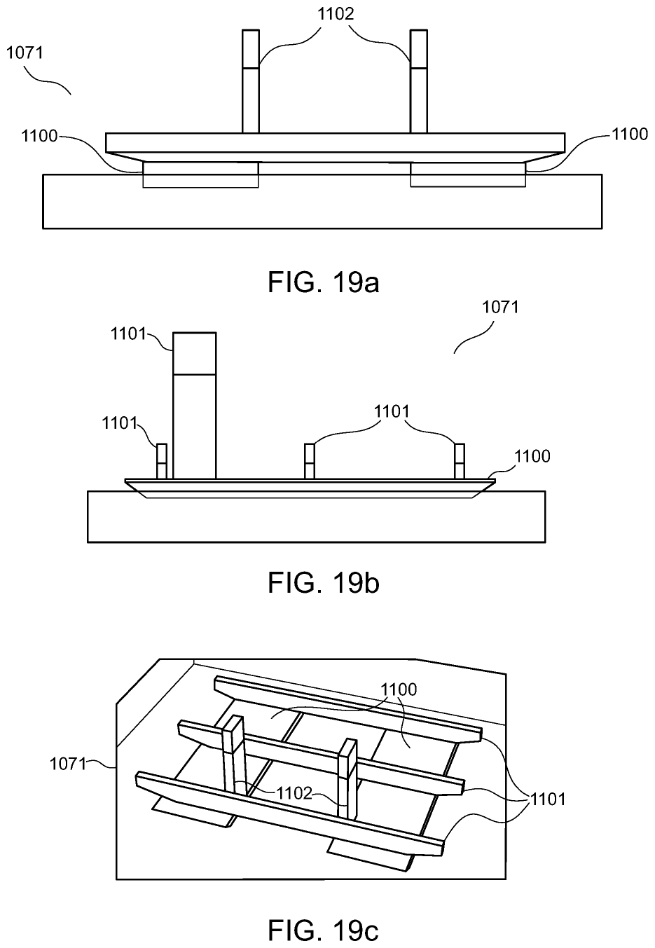

In FIGS. 19a to 20c there is shown an example embodiment of the second body 1071 according to the system of the present embodiment. In this example embodiment the second body 1071 is a selectively submersible body comprising a plurality of submersible barges, vessels or the like 1100 coupled together with a plurality of heavy capacity beams 1101. The second body comprises may comprise superstructures 1102 to support and/or attach to the one or more parts of the structure 1010 during transport of the parts to the assembly area and/or during construction of the structure 1010. The superstructures 1102 are preferably configurable such that the superstructures 1102 are above the water line when the second body 1071 is submersed in the water (see FIGS. 20a to 20b).

Alternatively, the second body 1071 may be a floating or buoyant body. The second body 1071 may be stabilised relative to a bed or floor of a body of water below the lifting arrangement 1020 using a second stabilising arrangement.

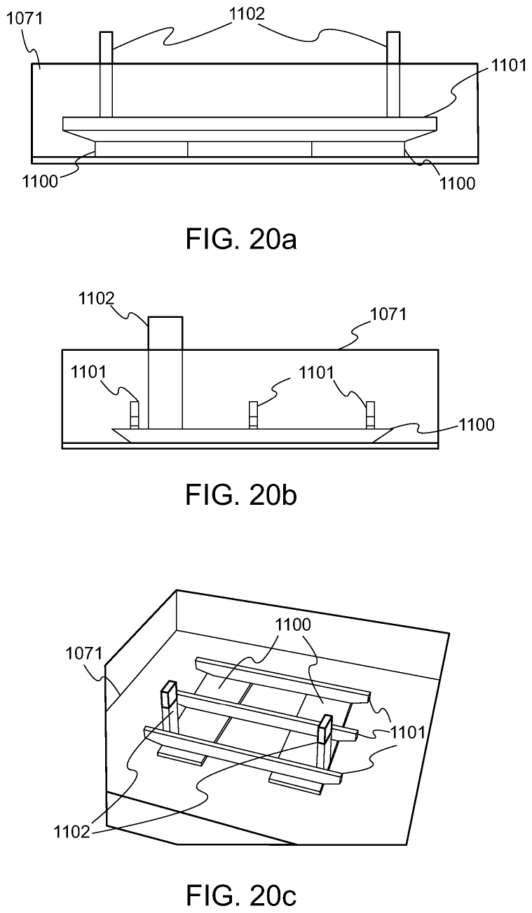

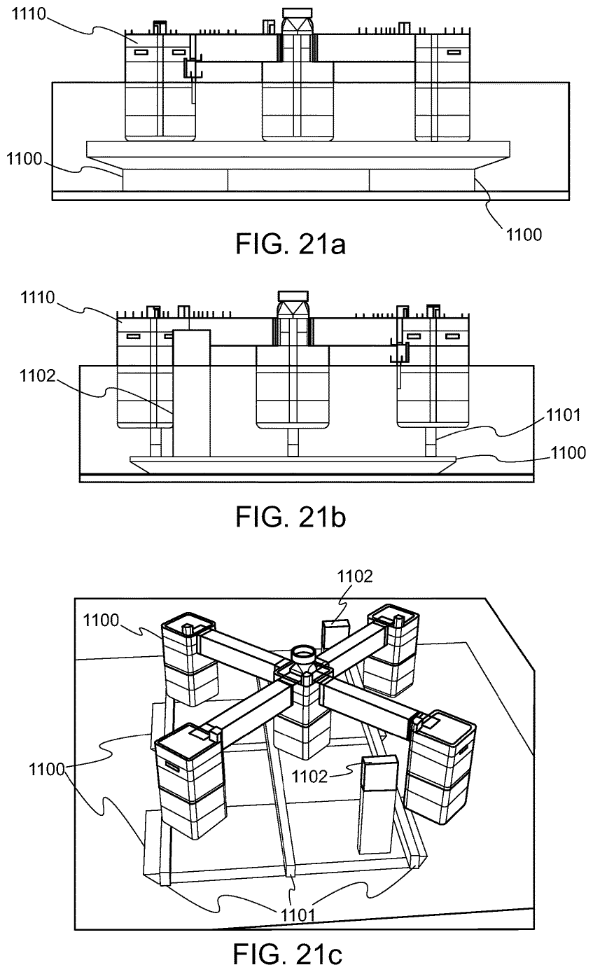

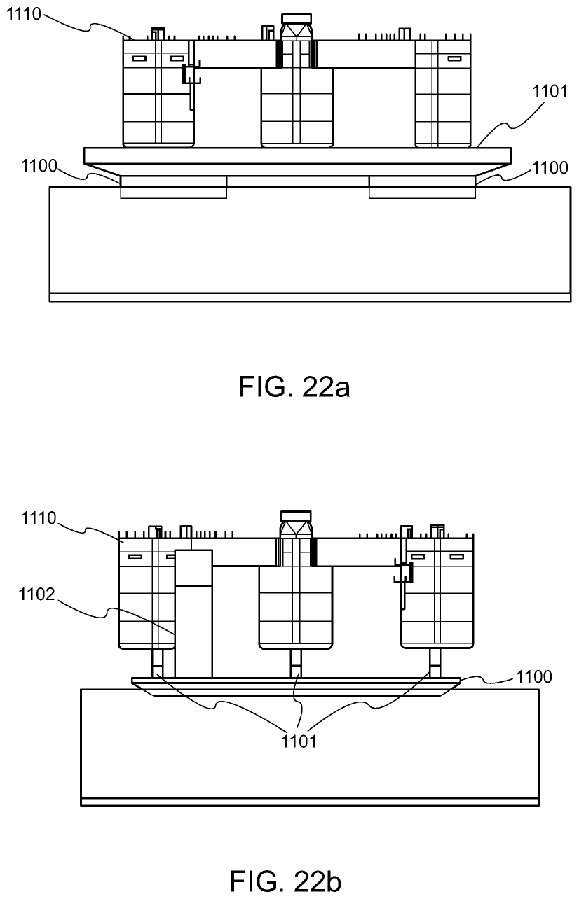

In FIGS. 21a to 22b there is shown an example embodiment of the second body 1071 onto which a floating/buoyant base or foundation body 1110 of the structure 1010 has been loaded, coupled and or attached. In use, the second body 1071 is selectively submerged such that the floating base 1110 can be positioned above the submerged second body 1071. The base 1110 is then attached and/or coupled onto the second body using the plurality of heavy capacity beams 1101 and/or the superstructures 1102 such that the base 1110 is securely coupled to the second body 1071.

The second body 1071 may then be selectively buoyed (see FIGS. 22a and 22b), thereby lifting the base 1110 above the level of the water allowing it to be transported to the assembly area.

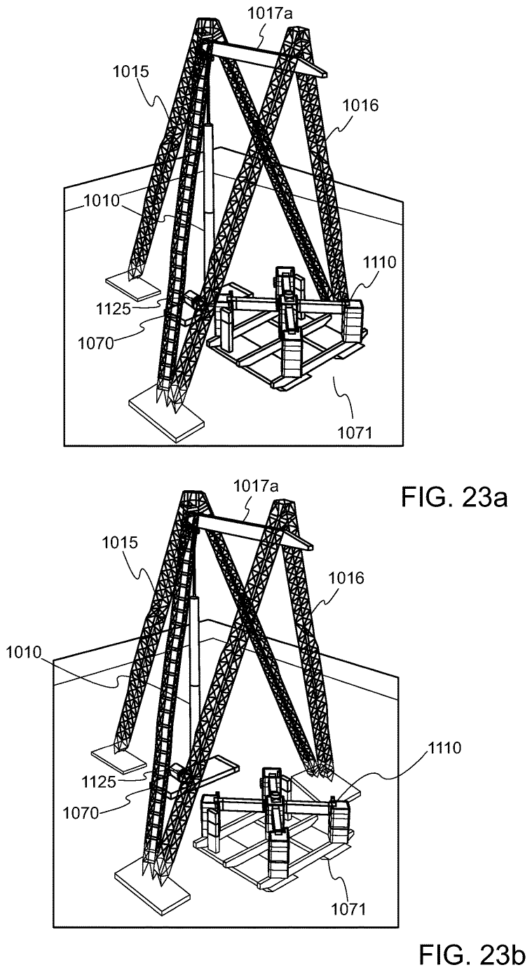

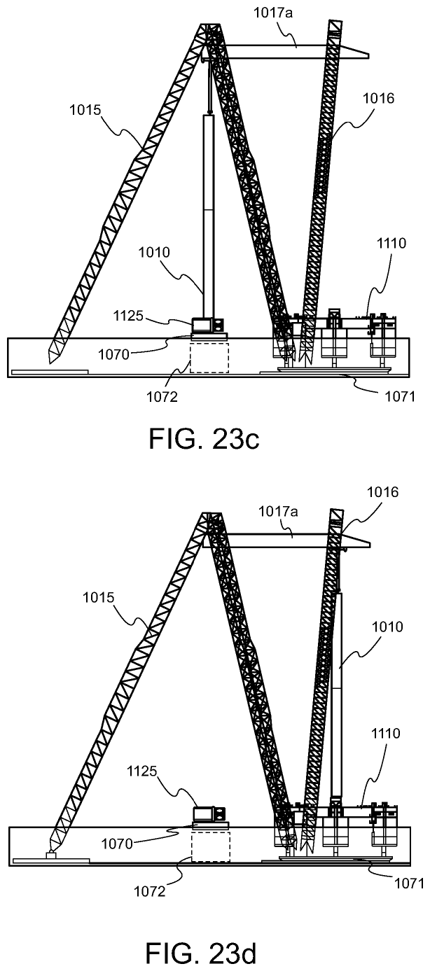

Referring now to FIGS. 23a to 23d there is shown a system, according to the tenth embodiment of the present disclosure. In this example, the system is used to lift assembled column parts 1115, 1120 onto floating base 1110 of structure 1010 which is loaded onto the second body 1071.

As described above with reference to FIGS. 21a to 22b the floating base 1110 is loaded onto the second body 1071 and transported to the assembly area. The second body 1071 is positioned below the elongate structure 1017a (see FIG. 23a). The second body 1071 may then be selectively submerged such that it is disposed on the sea bed stabilising the second body 1071 (see FIG. 23b).

The lifting arrangement 1020 is used to lift the assembled column parts 1115, 1120 off the first body 1070 (see FIG. 23c) and onto the floating base 1110 (see FIG. 23d) which is securely coupled to the stabilised second body 1071. The assembled column parts 1115, 1120 are then coupled to the floating base 1110. This process can then be repeated for additional parts (e.g. a nacelle 1125) of the structure 1010.

Once the additional parts of the structure 1010 have been assembled, the second body 1071 may be selectively buoyed. In the present example the second body 1071 may then be positioned under the cantilever portion of the elongate structure 1017a such that the plurality of blades 1130, 1131, 1132 can be coupled onto the structure 1010 whilst the second body 1071 is floating e.g. whilst moored, anchored or the like. Alternatively, the second body 1071 can be selectively submerged under the cantilever portion of the elongate structure 1017a such that it is stabilised on, or relative to, the sea bed.

The present disclosure provides a method of deploying an apparatus 1005 for assembling an (offshore) structure 1010, such as a wind turbine, such as an (floating/buoyant) offshore structure, wind turbine or jacket. The method may comprise providing at or to an assembly area or location an apparatus 1005 according to the ninth aspect and deploying/erecting the apparatus 1005.

The step of providing the apparatus 1005 to the assembly area may comprise use of one or more vessels or barges 1100.

Deploying/erecting the apparatus 1005 may comprise erecting the first erectable structure 1015, such that the first erectable structure 1015 when erected stands/sits on a bed of a body of water. An example method of erecting the first erectable structure 1015 is described above with reference to FIGS. 1 to 3b of the present disclosure.

Deploying/erecting the apparatus 1005 comprises erecting the second erectable structure 1016, such that the second erectable structure 1016 when erected stands/sits on the bed of the body of water.

Erecting the second erectable structure 1016 may comprise coupling, with a hingeable arrangement, an end of each of the second plurality of legs 1033, 1034 to a respective support structure, such as a mud mat 1038. Each of the second plurality of legs 1033, 1034 may be disposed to extend in a first direction in a/the first or collapsed or stowed state.

Deploying/erecting the apparatus may comprise transitioning the second erectable structure 1016 from the first or collapsed or stowed state and to a/the second or expanded state by rotating each of the second plurality of legs 1033, 1034 about the hingeable arrangement such that each of the second plurality of legs 1033, 1034 is disposed to extend in a second direction, the second direction being more upright than the first direction.

Deploying/erecting the apparatus comprises using at last one lifting device, such as a lifting device coupled to the first erectable structure 1015 and/or the second erectable structure 1016, to lift the elongate structure 1017/1017a.

Deploying/erecting the apparatus 1005 comprises coupling the elongate structure 1016 to the first and second erectable structures 1015, 1016.

It would be appreciated that the steps of the present embodiment may be performed in a temporal order that is different from the order of description. For example, the second erectable structure 1016 may be erected before or after the first erectable structure 1015.

The present disclosure provides a method of assembling a structure or wind turbine, such as an offshore structure 1010, wind turbine or jacket. The method comprises: deploying the apparatus 1005 according to the aforementioned method; disposing a first base or body 1070 at the assembly area substantially below at least a portion of the first erectable structure 1015; disposing a second base or body 1071 at the assembly area substantially below at least a portion the second erectable structure 1016; and assembling the structure 1010 by configuring the lifting arrangement 1020 to lift a component of the structure 1010 from the first base or body 1070 towards the second base or body 1071.

The first base or body 1070 may comprise a floating/buoyant barge or vessel for carrying the component.

Disposing the first base or body 1070 at the assembly area may optionally comprise stabilizing the first base or body 1070 relative to a bed or floor of a body of water below the lifting arrangement 1020.

Stabilizing the first base or body 1070 may comprise configuring a first stabilizing arrangement 1072 such as a jack to limit movement of the first base or body 1070 relative to the bed or floor. Alternatively, stabilizing the first base or body 1070 may comprise mooring the first base or body 1070 or coupling the first base or body to a mud mat 1038 associated with the first base or body 1070.

The second base or body 1071 may comprise a floating/buoyant vessel, such as a floater 1110 for a wind turbine, for supporting the assembled structure 1010.

Disposing the second base or body 1071 at the assembly area may optionally comprise stabilizing the second base or body relative to a/the bed or floor of a/the body of water below the lifting arrangement 1020.

Stabilizing the second base or body 1071 may comprise disposing the second base or body 1071 on a grounded vessel. Alternatively stabilizing the second base or body 1071 may comprise disposing the second base or body 1071 on a floating vessel, disposing the second base or body 1071 on the seabed or mooring the second base or body 1071.

It would be appreciated that the steps of the present embodiment may be performed in a temporal order that is different from the order of description. For example, the second base or body 1071 may be disposed at the assembly area before or after the first base or body 1070.

In some embodiments, the first and/or a second stabilizing arrangement may comprise at least one panel or member. The at least one panel or member may comprise an inflatable element. The at least one panel or member, e.g. the inflatable element, may comprise at least one layer of a drop-stitch material.

For example, a panel, or a stack of panels, of a drop-stitch material may provide a temporary buoyancy under first or second body instead of (or in some example embodiments, in addition to) using a barge or a vessel.

Advantageously, use of a drop-stitch material may provide a means of having a controllable volume of air, and hence a controllable means of creating a stabilizing buoyancy.

In an example, an inflatable bag, in which the volume and/or pressure of the inflated portion may be controlled, may be placed under the second base or body, e.g. under a hull of the floater 1110, and then inflated, thereby reducing a draft of the body, e.g. the floater 1110. The body could then be lowered to the seabed using the variable buoyancy, e.g. in a same way as a submersible barge.

That is, in an example embodiment, the floater 1110 may be disposed on one or more inflatable elements, such as inflatable elements comprising a drop-stitch material.

Optionally, stabilizing the second base or body may comprise controlling a volume or air in one or more inflatable elements disposed below and/or around at least a portion of the second base or body. For example, one or more inflatable elements, such as inflatable elements comprising a drop-stitch material, may be places under a hull of the floater 1110, e.g. under each teg or spar of the floater 1110. In some examples, such an inflatable element may extend under and/or around at least a portion of the base or body, e.g. under and/or around a leg or spar of the floater 1110.

In some examples, the inflatable element may be provided as a modular inflatable element. In some examples, the inflatable element may be provided as an assembly or stack of inflatable elements, e.g. sub-elements. In some examples, the/each inflatable element may for an enclosure or substantial cup-shape or receiving portion for receiving and or holding and or at least partially surrounding a leg or portion of the second body or base.

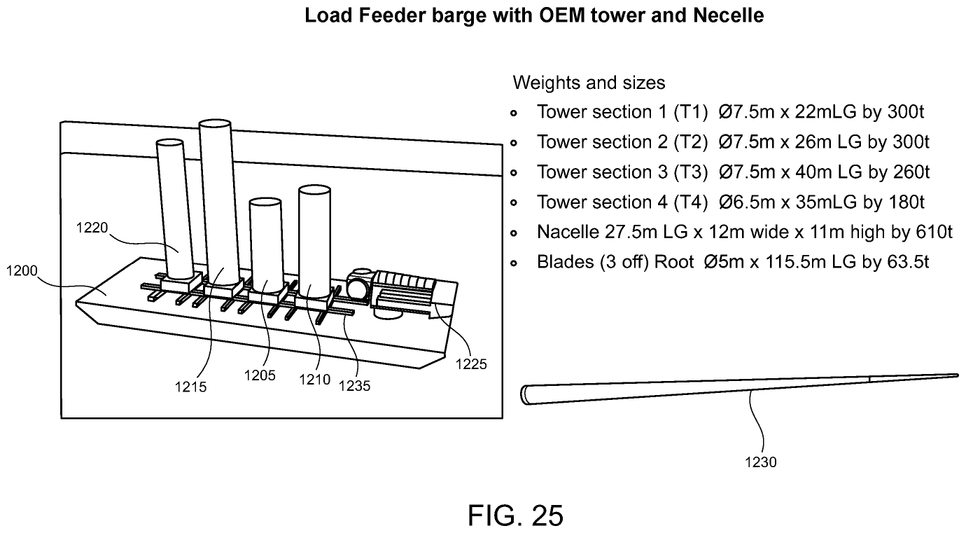

A method of assembling an offshore wind turbine, such as a floating offshore wind turbine, according to an embodiment of the disclosure is now described with reference to FIGS. 25 to 36.

FIG. 25 depicts a vessel 1200, which may be referred to in the art as a load feeder barge. The vessel 1200 is depicted carrying components of an offshore wind turbine, for use in the method of assembling the offshore wind turbine.

For purposes of example only, the components comprise a first tower section 1205, a second tower section 1210, a third tower section 1215 and a fourth tower section 1220. The first to fourth tower sections 1205-1220 may be assembled into a tower, as described in more detail below. It will be appreciated that in other embodiments, fewer than or greater than three tower portions may be assembled to provide the tower.

For purposes of example only, illustrative dimensions are provided. For example: the first tower section 1205 has a diameter of approximately 7.5 meters, a length of 22 meters and a weight of 300 tonnes, the second tower section 1210 has a diameter of approximately 7.5 meters, a length of 26 meters and a weight of 200 tonnes; the third tower section 1215 has a diameter of approximately 7.5 meters, a length of 40 meters and a weight of 260 tonnes; and the fourth tower section 1220 has a diameter of approximately 6.5 meters, a length of 35 meters and a weight of 180 tonnes. Also depicted is a nacelle 1225 having dimensions of approximately 27.5×12×11 meters and a weight of 610 tonnes. Also depicted is a blade 1230, which may have a root diameter of approximately 5 meters and a length of 115.5 m and a weight of 63.5 tonnes.

In some examples, the blades 1230 may be provided to the assembly area using a further vessel 1230, e.g. a feeder barge, which may be generally known in the art as the “blade feeder barge”

The vessel 1200 is depicted with a seafastening grillage 1235 for supporting the plurality of tower portions 1205-1220. The grillage 1235 may be raised to allow access by personnel to an interior of each tower portion 1205-1220.

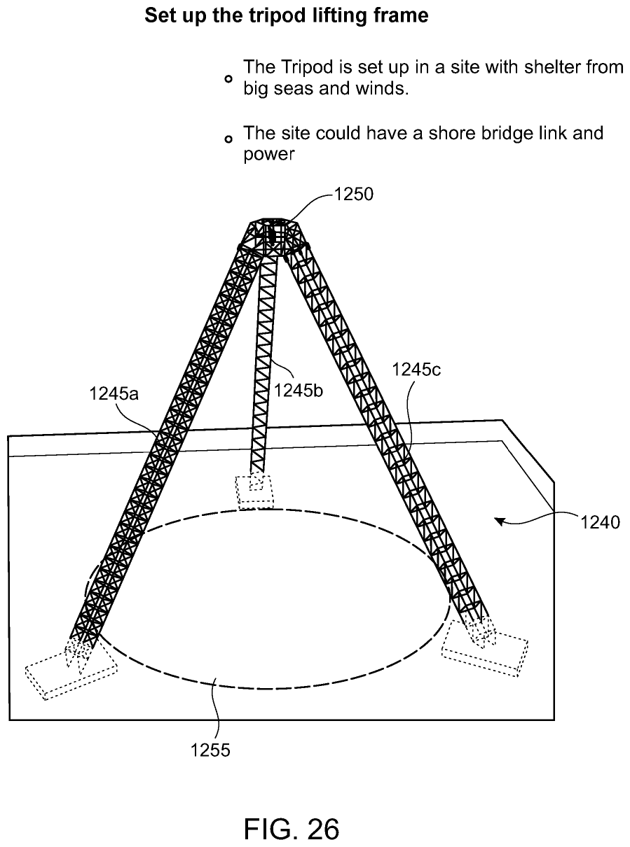

FIG. 26 depicts the support apparatus 1240. In the example embodiment, the support apparatus 1240 comprise an erectable tripod structure.

The support apparatus 1240 comprises a first leg 1245a, a second leg 1245b and a third leg 1245c. The plurality of legs 1245a-c of the support apparatus 1240, e.g. the erectable tripod structure, may be connected to or connectable to a connection member, hereafter referred to as an apex member 1250.

As described above, the support apparatus 1250 may comprise, or may substantially correspond to, the device or apparatus for assembling a structure of the first or seventh aspect, or the apparatus for assembling a structure of the ninth aspect. The support apparatus may, for example, comprise the tripod structure depicted in FIG. 3a or the tripod structure of FIG. 26.

As described above, the support apparatus 1240, e.g. the erectable tripod structure, may be disposable in a first or collapsed state, and may be disposable in a second or expanded state as depicted in FIG. 26. Each of the plurality of legs 1245a-c may be attached, e.g., hingably attached, at a first end to the apex member 1250. In the example, each leg 1245a-c is provided at a second end with a mud mat. Optionally the/each mud mat may be selectively buoyant or submersible.

An assembly area 1255 is depicted, wherein said assembly area 1255 is provided below the support apparatus 1240.

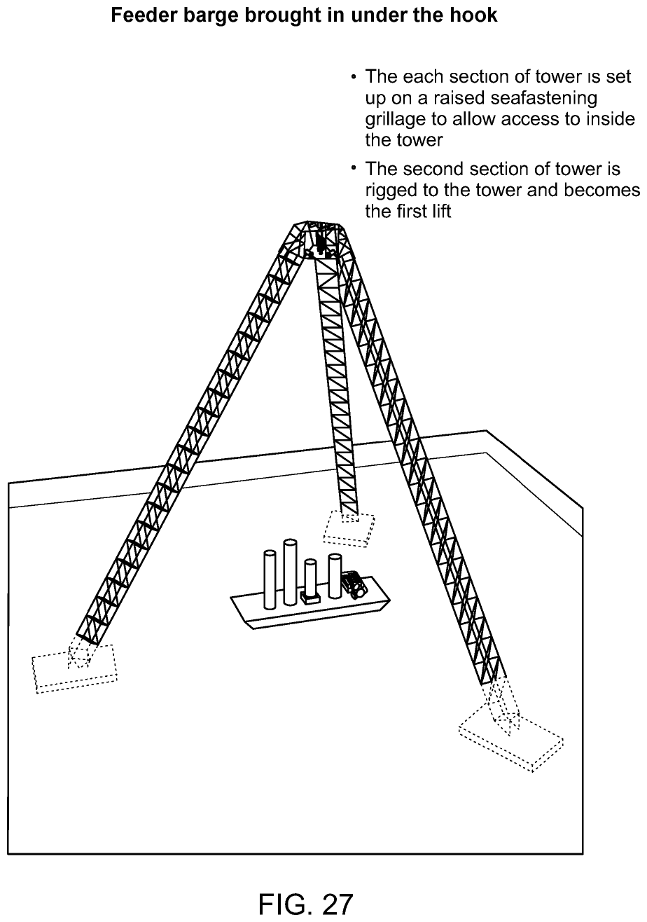

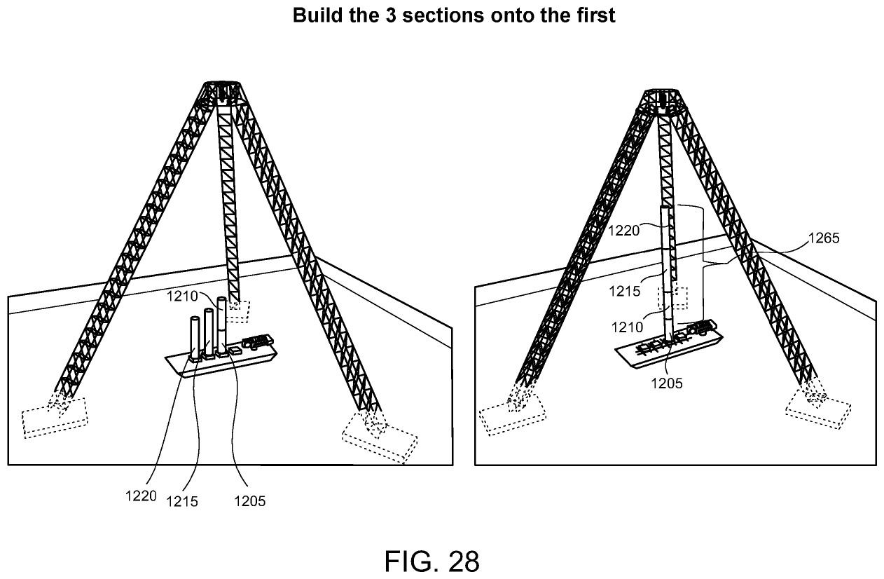

As depicted in FIG. 27, in a step of assembling an offshore wind turbine the vessel 1200 is transported to the assembly area 1255. In the example of a tower comprising four tower portions, the second tower portion 1210 may be rigged to the support apparatus 1240, such that the second tower portion 1210 may be a first component of the tower to be lifted by a lifting arrangement 1260 of the support apparatus 1240. This can be seen in FIG. 28, wherein initially the second tower portion 1210 is stacked on the first tower portion 1205, and the third tower portion 1215 and then fourth tower portion 1220 are then stacked to provide the assembled tower 1265.

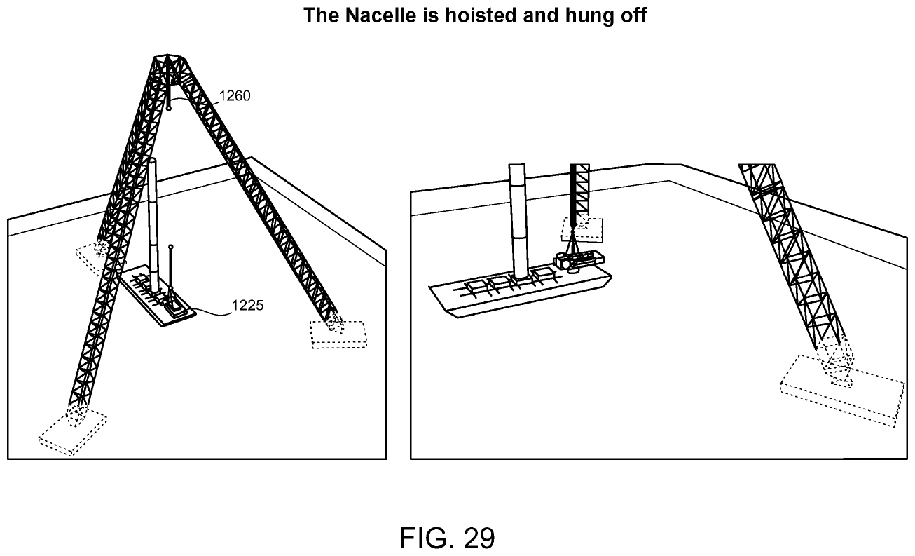

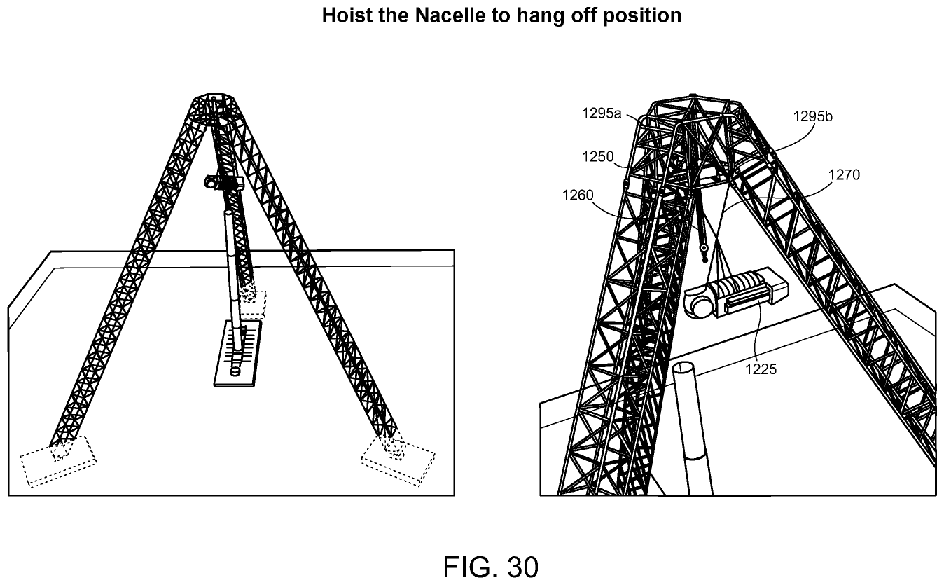

FIGS. 29 and 30 depict steps of hoisting the nacelle 1225 and suspending the nacelle 1225 from the support apparatus 1240.

In the example, a plurality of lines or slings 1270 may be employed to suspend the nacelle 1225 in a holding position. In the example, the holding position may be offset from a vertical axis extending through an apex of the support apparatus 1240. That is, in examples the nacelle 1225 may be effectively stored on the support apparatus 1240, e.g. below or substantially below or adjacent the apex member 1250 of the support apparatus 1240, until it is later required for landing on the tower 1265.

In the example, the support apparatus 1240 comprises a support arrangement 1295a-b for supporting the nacelle 1225. In the example, the support arrangement 1295 a-b comprises a plurality of couplings or nodes 1295a, 1295b. The couplings or nodes 1295a, 1295b are provided on the apex member 1250, although it will be appreciated that such couplings or nodes 1295a, 1295b may additionally or alternatively be provided on at least one leg 123a-c of the support structure 1240. Such couplings or nodes 1295a, 1295b may, for example, comprise any of padeyes, shackles, fastenings, clips or the like. The plurality of lines or slings 1270 may be coupled to the couplings or nodes 1295a, 1295b.

In a next step depicted in FIG. 31, the vessel 1200 is manoeuvred such that the tower 1265 is disposed below, e.g. directly below, the lifting arrangement 1260.

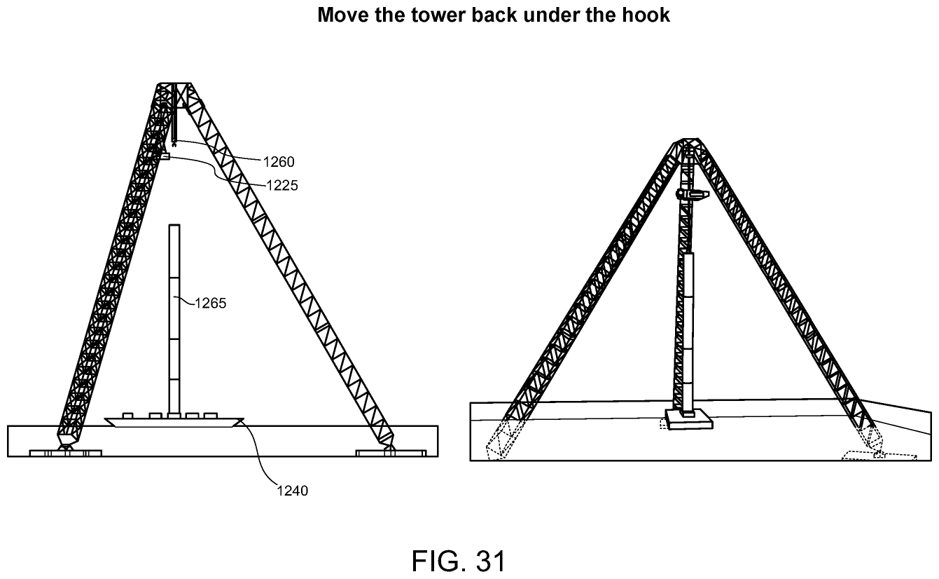

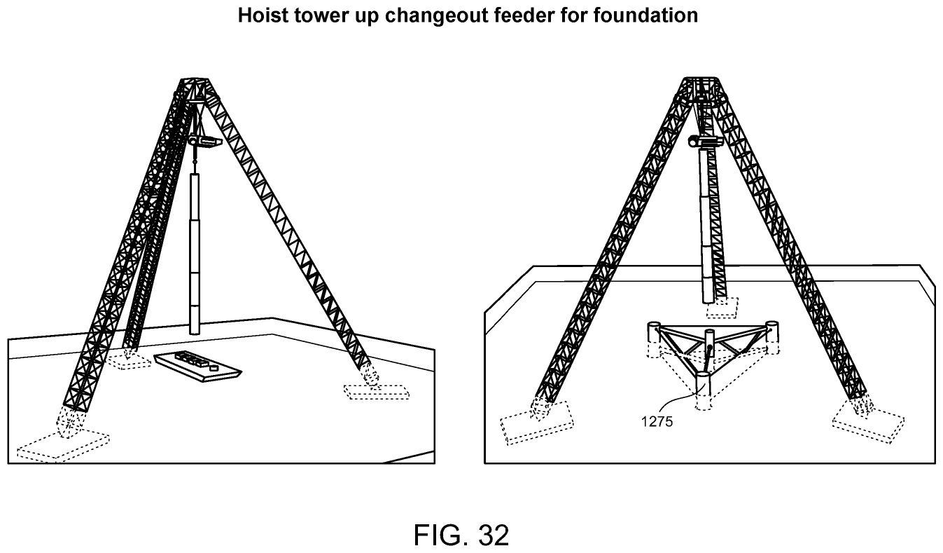

In a next step depicted in FIG. 32, the assembled tower 1265 is lifted by the lifting arrangement 1260. As such, both the assembled tower 1265 and the nacelle 225 are suspended from the support apparatus 1240, and only a single substantial marine operation with vessel 1240 has been carried out.

In a next step also depicted in FIG. 32, the vessel 1200 is manoeuvred away from the position directly below the lifting apparatus 1260, such as to a position outside the assembly area 1255.

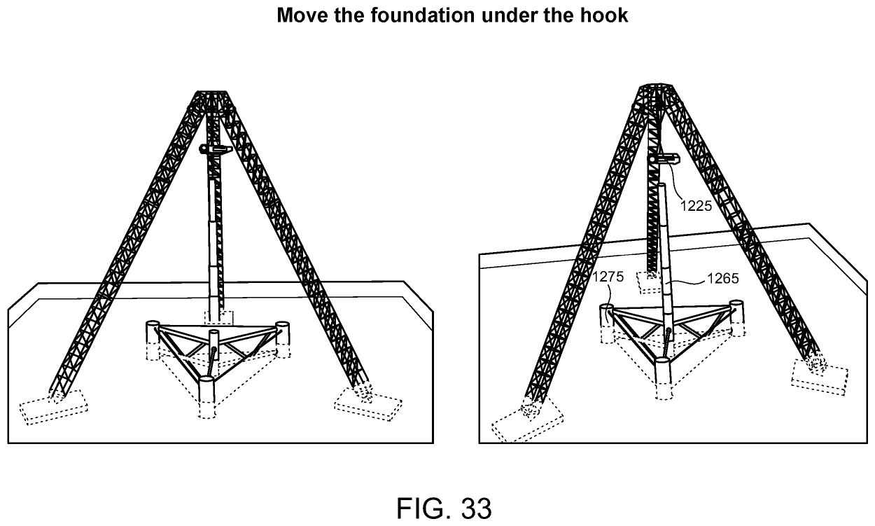

As also depicted in FIGS. 32 and 33, a floating/buoyant base or foundation body, which in the example is a floater 1275, is manoeuvred to below, e.g. directly below, the lifting arrangement 1260.

In examples, the floating/buoyant base or foundation body may comprise: a floater 1275; a floating spar; a tension-leg platform; a barge; or a semi-submersible platform.

Furthermore, in some examples the method may comprise a step of stabilizing the floating/buoyant base or foundation body, e.g. the floater 1275, relative to a bed or floor of a body of water at the assembly area 1255 using a stabilising arrangement (not depicted) comprising at least one of: a jack; a mooring arrangement; an anchor arrangement; and/or a grounded vessel. An example of such a process of stabilizing the floater 1270 is described above with reference to the example of FIGS. 19a to 22b, which may be applicable to the present embodiment.

Advantageously, stabilizing the floater 1275 relative to the bed or floor of a body of water may enable static-to-static lift operations when landing the nacelle 1225 on the assembled tower 1265, thereby minimising a risk of damage to the tower 1265 and/or nacelle 1225 and simplifying assembly operations.

As also depicted in FIG. 33, the assembled tower 1265 may then be landed on the floater 1270.

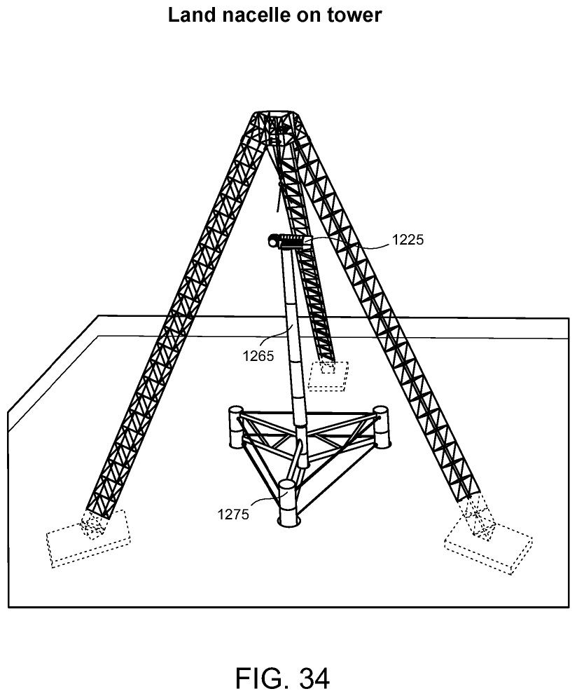

Next, as depicted in FIG. 34, the nacelle 1225 is landed on the assembled tower 1265. In a non-limiting example, landing the nacelle 1225 on the tower 1265 may comprise a step of cross-hauling the nacelle 1225 from the holding position to a landing position substantially below the apex, e.g. apex member 1250, of the support apparatus 1240.

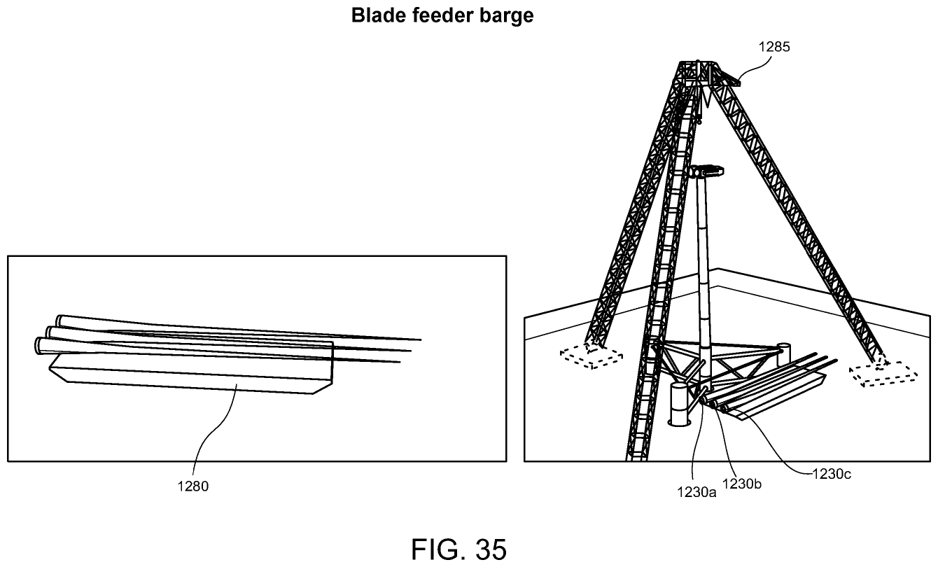

FIG. 35 depicts a further vessel 1280, which in this example is a blade feeder barge. The further vessel 1280 carries blades 1230a-c for coupling to the nacelle 1225. The further vessel 1280 is manoeuvred substantially alongside the floater 1275

Also depicted is a cantilever portion 1285 extending from the support apparatus 1240. In the example, the cantilever portion 1285 extends from the apex member 1250 of the support apparatus 1240. It will be appreciated that in other embodiments falling within the scope of the disclosure, the cantilever portion 1285 may, for example, additionally or alternatively extend from a leg 1245a-c of the support apparatus 1240. In example embodiments, the cantilever portion 1285 may be detachable from the support apparatus 1240. In example embodiments, the cantilever portion 1285 may be configurable to selectively extend from the support apparatus 1240, e.g. from a leg 1245a-c and/or apex member 1250 of the support apparatus 1240. For example, the cantilever portion 1285 may have a hinged connection to the support apparatus.

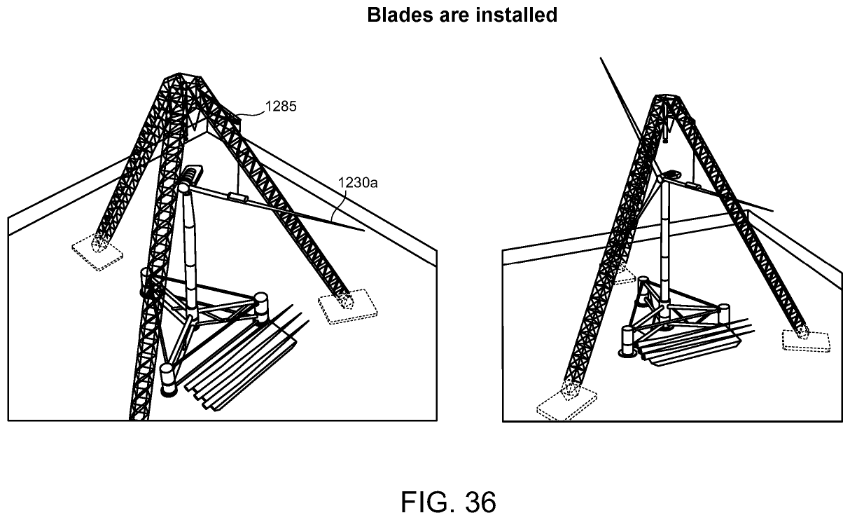

FIG. 36 depicts a step of installing the blades 1230a-c of the offshore wind turbine, according to an embodiment of the disclosure (note that in FIG. 36, the blades 1230a-c are also depicted on the further vessel 1280 for purposes of illustration only).

In the example, a line extends from the cantilever portion 1285 to support each blade 1230a-c during assembly of the offshore wind turbine. The line may extend to a clamping device 1290 or other support, wherein the clamping device 1290 or other support provides support to each blade 1230a-c during assembly of the offshore wind turbine. Although the disclosure has been described in terms of preferred embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

### CLAUSES

1. An apparatus for assembling a structure such as a wind turbine or jacket, the apparatus comprising:
   a first erectable structure comprising a first plurality of legs connected by a first connection arrangement;
   a second erectable structure comprising a second plurality of legs connected by a second connection arrangement;
   an elongate structure extending between the first and second erectable structures; and
   a lifting arrangement configurable to move a load along the elongate structure between the first and second erectable structures.
2. The apparatus according to clause 1, wherein the first and/or second erectable structure is:
   disposable in a first or collapsed or stowed state and a second or expanded state; and
   expandably erectable or selectively movable from the first state to the second state; and
   collapsible or stowable or further selectively movable from the second state to the first state.
3. The apparatus according to clause 1 or 2, wherein:
   the first connection arrangement comprises a first apex member substantially defining a first apex of the first plurality of legs;
   the second connection arrangement comprises a second apex member substantially defining a second apex of the second plurality of legs.
4. The apparatus according to clause 3, wherein the elongate structure extends directly below the first apex and the second apex.
5. The apparatus according to any preceding clause, wherein:
   the first erectable structure comprises a tripod or tripod arrangement, wherein the first plurality of legs has exactly three legs; or
   the first erectable structure comprises a tetrapod or tetrapod arrangement, wherein the first plurality of legs has exactly four legs.
6. The apparatus according to any preceding clause, wherein:
   the second erectable structure comprises a tripod or tripod arrangement, wherein the second plurality of legs has exactly three legs; or
   the second erectable structure comprises a pair of shear legs or an A-Frame arrangement, wherein the second plurality of legs has exactly two legs.
7. The apparatus according to any preceding clause, wherein:
   each leg of the first plurality of legs is attached at, or substantially at, a respective first end to the first connection arrangement;
   each leg of the second plurality of legs is attached at, or substantially at, a respective first end to the second connection arrangement;
   each leg of the first and second plurality of legs is provided at a respective second end with a mud mat, optionally the/each mud mat being selectively buoyant or submersible.
8. The apparatus according to clause 7, wherein each leg of the second plurality of legs is hingeably coupled at the second end with the respective mud mat.
9. The apparatus according to any preceding clause, wherein the elongate structure comprises a beam or truss, and optionally wherein the elongate structure comprises a rail, channel or guide along which at least a portion of the lifting arrangement is configured to be moved or conveyed.
10. The apparatus according to any preceding clause, wherein a cantilevered portion of the elongate structure extends from the second erectable structure in a direction away from the first extendable structure, and optionally wherein the cantilevered portion is a tapered portion.
11. The apparatus according to any preceding clause, wherein:
   the lifting arrangement comprises an arrangement for connecting or supporting a part of the structure to be assembled;
   the lifting arrangement comprises one or more hooks or shackles;
   the lifting arrangement comprises a single point lifting arrangement; and/or
   the lifting arrangement comprises one or more pulley and/or winch arrangements.
12. The apparatus according to any preceding clause, wherein each leg of the first and/or second plurality of legs comprise a lattice or truss arrangement.
13. The apparatus according to any preceding clause, wherein each leg of the first and/or second plurality of legs is configured to be extendable, and optionally wherein each leg of the first and/or second plurality of legs is configured to be extended by insertion of an extension portion to the respective leg.
14. A system for assembling a structure such as a wind turbine or jacket, comprising the apparatus according to any of clauses 1 to 13.
15. the System for Assembling a Structure According to Clause 14, Wherein the system comprises:
   a first body for transporting one or more parts of the structure to an assembly area provided below the lifting arrangement, wherein the first body is a floating or buoyant body and optionally comprising a first stabilizing arrangement for stabilizing the first body relative to a bed or floor of a body of water below the lifting arrangement.
16. The system for assembling a structure according to clause 14 or 15, wherein the system comprises:
   a second body for assembling the structure on, and optionally comprising a second stabilizing arrangement for stabilizing the second body relative to a bed or floor of a body of water below the lifting arrangement, and optionally wherein the second body is a floating or buoyant body.
17. The system for assembling a structure according to clause 16, wherein the first and/or second stabilizing arrangement comprises at least one panel or member, the at least one panel or member comprising at least one layer of a drop-stitch material.
18. A method of deploying an apparatus for assembling a structure such as a wind turbine or jacket, the method comprising:
   providing at or to an assembly area or location an apparatus according to any of clauses 1 to 13; and
   deploying/erecting the apparatus.
19. The method of clause 18, wherein deploying/erecting the apparatus comprises:
   erecting the first erectable structure, such that the first erectable structure when erected stands/sits on a bed of a body of water;
   erecting the second erectable structure, such that the second erectable structure when erected stands/sits on the bed of the body of water;
   using at last one lifting device, such as a lifting device coupled to the first erectable structure and/or the second erectable structure, to lift the elongate structure; and
   coupling the elongate structure to the first and second erectable structures;
   wherein the elongate structure is provided with the lifting arrangement configurable to move the load along the elongate structure between the first and second erectable structures, and wherein after deployment/erection of the apparatus the lifting arrangement is provided above a surface level of the body of water.
20. The method of clause 19, wherein erecting the second erectable structure comprises:
   coupling, with a hingeable arrangement, an end of each of the second plurality of legs to a respective support structure, such as a mud mat, wherein each of the second plurality of legs is disposed to extend in a first direction in a/the first or collapsed or stowed state; and
   transitioning the second erectable structure from the first or collapsed or stowed state and to a/the second or expanded state by rotating each of the second plurality of legs about the hingeable arrangement such that each of the second plurality of legs is disposed to extend in a second direction,
   wherein the second direction is more upright than the first direction.
21. A method of assembling a structure, such as a wind turbine or a jacket, the method comprising:
   deploying the apparatus according to the method of any of clauses 18 to 20;
   disposing a first base or body at the assembly area substantially below at least a portion of the first erectable structure;
   disposing a second base or body at the assembly area substantially below at least a portion the second erectable structure;
   assembling the structure by configuring the lifting arrangement to lift a component of the structure from the first base or body towards the second base or body.
22. The method of assembling a structure according to clause 21, wherein the first base or body comprises a floating/buoyant barge or vessel for carrying the component.
23. The method of assembling a structure according to clause 21 or 22, wherein disposing the first base or body at the assembly area comprises:
   stabilizing the first base or body relative to a bed or floor of a body of water below the lifting arrangement; and
   optionally wherein stabilizing the first base or body comprises configuring a stabilizing arrangement such as a jack to limit movement of the first base or body relative to the bed or floor.
24. The method of assembling a structure according to any of clauses 21 to 23, wherein the second base or body comprises a floating/buoyant vessel, such as a floater for a wind turbine, for supporting the assembled structure.
25. The method of assembling a structure according to any of clauses 21 to 24, wherein disposing the second base or body at the assembly area comprises:
   stabilizing the second base or body relative to a/the bed or floor of a/the body of water below the lifting arrangement; and
   optionally wherein stabilizing the second base or body comprises at least one of:
   disposing the second base or body on a grounded vessel;
   disposing the second base or body on a floating vessel;
   disposing the second base or body on the seabed; and/or mooring the second base or body.
26. The method of assembling a structure according to any of clauses 21 to 25, wherein the structure comprises or includes:
   a plurality of parts or components;
   a segmented (offshore) structure
   a floating/buoyant foundation;
   a monopile;
   a jacket, e.g., a three-leg jacket, a four-leg jacket or a twisted jacket.
27. The method of assembling a structure according to any of clauses 21 to 26, wherein in the case of the structure comprising a wind turbine:
   the wind turbine comprises a plurality of parts or components comprising one or more of:
      a column or tower section;
      a nacelle;
      a plurality of turbine blades.
28. An apparatus for assembling a structure such as an offshore structure, wind turbine or jacket, the device or apparatus comprising:
   an erectable structure; and
   a post or column configured to extend through a central portion of the erectable structure.
29. The apparatus of clause 28, wherein the post or column is mounted on a floating structure.
30. The apparatus of clause 28 or 29, wherein the central portion of the erectable structure is configured to be walked up the post or column during a process of erection of the erectable structure.
31. The apparatus of clause 30, comprising one or more walking clamps for walking the central portion of the erectable structure up the post or column.
32. The apparatus of clause 30 or 31, wherein the central portion comprises a running gear module configured to be run up and down the post or column.
33. The apparatus of clause 32, wherein:
   the post or column comprises one or more winches at an upper or top portion, the one or more winches configured to lift an upper or top portion of the erectable structure; or
   when dependent upon clause 29, the post or column comprises one or more return sheaves, and winches at, on, or in the general proximity of, a deck of the floating structure.
34. The apparatus of any of clauses 28 to 33, wherein the post or column comprises a primary post or column comprising at least one further post or column disposed inside the primary post or column, wherein the primary post or column and the at least one further post or column are arranged in a telescopic arrangement.
35. The apparatus of any of clauses 28 to 34, wherein the erectable structure comprises a tripod comprising three legs, and further comprising a mud-mat barge at a base portion of each leg.
36. The apparatus of clause 35, comprising:
   a first plurality of pin and clevis arrangements configured to couple a top assembly to the three legs; and
   when dependent on clause 32, a second plurality of pin and clevis arrangements configured to fix the running gear module to the three legs.
37. The apparatus of clause 35 or 36, comprising tension members disposed between bases of the legs.
38. The apparatus of any of clauses 35 to 37, wherein each mud-mat barge is ballasted by at least one of:
   water, mud or haematite;
   sheet piles disposed around each mud-mat barge;
   piled anchors;
   suction anchors; or
   dry anchors attached by chain, wire or rope securing lines to the shore.
39. The apparatus of any of clauses 28 to 38, wherein the erectable structure is:
   expandable or selectively movable from a first or collapsed state to the second expanded or erected state; and
   collapsible or further selectively movable from the second state to the first state.
40. A method of erecting an erectable structure, the method comprising:
   providing an erectable structure; and
   providing a post or column configured to extend through a central portion of the erectable structure; and
   raising a central portion of the erectable structure relative to the post or column.
41. The method of clause 40, comprising transporting the erectable structure in a collapsed state to a location for assembling an offshore structure and then, when at the location, erecting the erectable structure.
42. The method of clause 40 or 41, wherein the erectable structure is installed in pieces that are joined together on a deck and/or lowered over the top of, and/or assembled around, the post or column.
43. The method of any of clauses 40 to 42, wherein erection of the erectable structure comprises walking the central portion of the erectable structure up the post or column using one or more walking clamps.
44. The method of any of clauses 40 to 43 wherein, while the central portion of the erectable structure is being raised:
   a pulling force is applied to tension members between a centre and a base of legs of the erectable structure; or
   a pulling force is applied to tension members between bases of legs of the erectable structure.
45. The method of any of clauses 40 to 44, wherein providing the post or column comprises providing the post or column on a floating structure with the top of the erectable structure placed around the post or column.
46. The method of clause 45, comprising lowering or extending the floating structure, or at least a portion thereof, to a seabed.
47. The method of any of clauses 40 to 46, comprising:
   fitting a one or more winches to the post or column;
   configuring the one or more winches to lift an upper or top portion of the erectable structure.
48. The method of any of clauses 40 to 47, wherein the post or column comprises a primary post or column comprising at least one further post or column disposed inside the primary post or column, wherein the primary post or column and the at least one further post or column are arranged in a telescopic arrangement, and wherein during assembly of the erectable structure, when an upper portion or top of the erectable structure is raised to reach the top or upper portion of the post or column, then the at least one further post or column may be is telescoped to enable a continuation of raising the upper portion or top of the erectable structure.
49. A device or apparatus for assembling a structure-such as a wind turbine or jacket, such as an offshore structure, wind turbine or jacket-the apparatus comprising an (vertically) erectable structure and a lifting arrangement.
50. A device or apparatus according to clause 49, wherein when erected:
   the apparatus comprises an assembly area, e.g., an area of water, e.g., above a bed or floor of a body of water, e.g., a seabed, below the lifting arrangement;
   the assembly area is provided below, e.g., directly below, the lifting arrangement, e.g., when erected;
   a/the assembly area is provided within a perimeter, area or volume of the device or apparatus; and/or
   the lifting arrangement is provided above, e.g., directly above, the assembly area.
51. A device or apparatus according to either of clauses 49 or 50, wherein:
   the structure is disposable in a first or collapsed state;
   the structure is disposable in a second or expanded state;
   the structure is expandable erectable or selectively movable from a/the first state to a/the second state; and/or
   the structure is collapsible or further selectively movable from a/the second state to a/the first state; and/or
   the structure is capable of being assembled and/or erected at site or in situ;
   the structure comprises a plurality of legs and/or an apex member, and optionally
      the legs are connected to or connectable to the apex member; and/or the lifting arrangement is, in use, provided below, e.g., directly below the apex member; and/or
      one or more of the legs are of different lengths.
52. A device or apparatus according to any of clauses 49 to 51, wherein:
   the device or apparatus comprises a tripod or tripod arrangement, or comprises a tetrapod or tetrapod arrangement, or comprises first and second adjacent towers; and wherein:
      in the case of a tripod the tripod comprises three legs;
      each of the legs is attached, e.g., hingably attached, at a first end to a connection member, wherein optionally the connection member comprises an apex of the tripod, and/or each leg is provided at a second end with a mud mat, optionally the/each mud mat being selectively buoyant or submersible,
wherein in the case of a tetrapod:
   a pair of opposing legs are of the same length, which length is different to a length of another pair of opposing legs;
   wherein in any case
   the lifting arrangement is attached to and/or depends (vertically downwardly) from a/the connection member or apex, such that the lifting arrangement is provided between the legs or towers.
53. a Device or Apparatus According to Any of Clauses 49 to 52, Wherein:
   the lifting arrangement comprises an arrangement for connecting or supporting a part(s) of the structure to be lifted;
   the lifting arrangement comprises one or more hooks or shackles;
   the lifting arrangement comprises a single point lifting arrangement; and/or
   the lifting arrangement comprises one or more pulley arrangements.
54. A device or apparatus according to any of clauses 49 to 53, wherein:
   one or more lines (control/mooring/tagging lines) are provided between at least one and preferably each of a plurality of/the legs or towers, the lines being adapted to be connected to a load—e.g., part of the structure-being lifted by the lifting arrangement, and optionally:
   a connection piece is provided at an intersection point of the lines, e.g., below the apex member.
55. A device or apparatus according to any of clauses 49 to 54, wherein:
   one or more legs of the device or apparatus comprise a (metal) lattice arrangement; and/or
   at or near ends of the legs distal the apex member there are provided further lines or cables extending between adjacent legs; and/or
   yet further lines are provided at or near end of each leg, which further lines extend (horizontally) so as to meet at a (base) centre point of the apparatus, e.g., below the apex member.
56. A system for assembling a structure-such as a wind turbine (generator) or jacket, such as an offshore structure, wind turbine (generator) or jacket-comprising the device or apparatus according to any of clauses 49 to 55.
57. A system for assembling a structure according to clause 56, wherein:
   the system comprises a floating or buoyant body for transporting one or more parts of the structure to an/the assembly area.
58. A system for assembling a structure according to either of clauses 56 or 57, wherein:
   the system comprises one or more winches, e.g., for controlling the lifting arrangement; and optionally wherein
   the one or more winches are provided on a further floating or buoyant body, wherein optionally:
      the further floating or buoyant body is adapted to be secured to a leg of the device or apparatus; and/or
      the further floating or buoyant body comprises a slotted or recessed portion for engagement with a leg of the device or apparatus and/or for receiving the connection member during transportation of the device/apparatus when in a collapsed state.
59. A method of deploying a device or apparatus for assembling a structure-such as a wind turbine (generator), such as an (floating/buoyant) offshore structure, wind turbine (generator) or jacket-the method comprising:
   providing at or to an assembly area or location a device or apparatus according to any of clauses 49 to 55; and
   deploying/erecting the device or apparatus.
60. A method of deploying a device or apparatus according to clause 59, wherein:
   the assembly location is an area of water, e.g., an area above a bed or floor of a body of water, e.g., a seabed;
   the device/apparatus when erected stands/sits on a bed of a body of water, e.g., a seabed;
   the apex and the lifting arrangement are provided above a surface level of the body of water; and/or
   the step of providing the device or apparatus to the assembly location comprises use of one or more vessels or barges, e.g., to transport the device or apparatus or one or more parts/components thereof, whether together or individually.
61. A method of assembling a structure or wind turbine (generator)—such as an offshore structure, wind turbine (generator) or jacket-the method comprising:
   deploying the device or apparatus according to the method of clauses 59 or 60;
   transporting a first part of the structure to the assembly area;
   lifting the first part using the lifting arrangement;
   transporting a floating/buoyant base or foundation body to the assembly area;
   connecting/clamping the first part of the structure to the floating/buoyant base body.
62. A method of assembling a structure or wind turbine according to clause 61, wherein the method comprises the subsequent step(s) of:
   transporting a further part of the structure to the assembly area;
   lifting the further part using the lifting arrangement;
   transporting the floating/buoyant base to the assembly area;
   lowering and/or connecting the further part of the structure to the first/a part of the structure already provided on the floating/buoyant base.
63. A method of assembling a structure or wind turbine according to either of clause 61 or 62, wherein the structure is a floating structure.
64. A method of assembling a structure or wind turbine according to any of clauses 61 to 63, wherein the structure comprises or includes:
   a plurality of parts or components;
   a segmented (offshore) structure
   a floating/buoyant foundation;
   a monopile;
   a jacket, e.g., a three-leg jacket, a four-leg jacket or a twisted jacket.
65. A method of assembling a structure or wind turbine according to any of clauses 61 to 63, wherein in the case of the structure comprising a wind turbine:
   the wind turbine comprises a plurality of parts or components comprising on or more of:
      column or tower, e.g., first and second column parts;
      a nacelle;
      a plurality of turbine blades, e.g., three turbine blades; and/or wherein
   the wind turbine comprises a given number of parts/six parts and so assembly requires a same given number of lifts/six lifts.
66. A method of assembling an (offshore) structure, such as an (offshore) wind turbine or (offshore) jacket, the method comprising the steps of:
   providing a lifting arrangement comprising:
      a gantry disposed over and/or directly above an area of water; and
      a lifting means or apparatus coupled to the gantry; and
   stacking portions of the structure by:
      conveyably disposing a first portion of the structure relative to or at the area of water:
      lifting the first portion using the lifting means;
      configuring a clamping or retaining device to grip the first portion; and
      conveying the clamping or retaining device away from the area of water;
      lifting a second portion of the structure using the lifting means or apparatus;
      disposing the first portion underneath or adjacent the second portion by further conveying the first portion gripped by the clamping device to the area of water; and
      lowering the second portion onto or so as to connect with the first portion.
67. A method of assembling an (offshore) structure according to clause 66, wherein: the step of lifting the second portion using the lifting means or apparatus comprises hoisting and/or raising the second portion in an upwards direction to a height above an uppermost level of first portion.
68. A method of assembling an (offshore) structure according to either of clauses 66 or 67, wherein:
   the method comprises a step of fixedly coupling the second portion to the first portion by bolting, welding, and/or clamping;
   the structure is a wind turbine assembly, such as an offshore wind turbine, or a jacket, such as an offshore jacket, e.g., for supporting a wind turbine; and/or
   the first portion and/or the second portion and/or one or more further portion(s) is/are at least one of: a portion of a tower or a nacelle or a turbine blade(s).
69. A method of assembling an (offshore) structure according to any of clauses 66 to 68, wherein the method further comprises the step of stacking a/the further portion on the second portion by:
   lifting the further portion using the lifting means or apparatus;
   disposing the second portion of the structure underneath the further portion by conveying the second portion rialto the area of water;
   lowering/moving the further portion onto/relative the second portion.
70. A method of assembling an (offshore) structure according to any of clauses 66 to 69, wherein:
   the clamping device is provided on a floating or buoyant body, e.g., a floating foundation or (top) crown assembly; and/or
   the clamping device is configured for supporting and/or clamping and/or gripping at least a portion of the structure in a vertical disposition and/or substantially upright configuration.
71. A system for assembling a structure, such as an (offshore) wind turbine or (offshore) jacket, the system comprising:
   a gantry disposed over and/or directly above an area of water;
   a lifting means or arrangement coupled to the gantry; and
   a means or device for conveying a portion of the structure to and from the area of water, wherein
   the means or device for conveying a portion of the structure comprises a clamping or retaining device.
72. A system for assembling a structure according to clause 71, wherein:
   the clamping or retaining device is configurable between a clamping or retention configuration for gripping a portion of the structure and a non-clamping or non-retention configuration.
   the clamping device is coupled to or mounted on a/the floating or buoyant base body, e.g., a floating foundation or (top) crown assembly or barge.
73. A system for assembling a structure according to either of clauses 71 or 72, wherein:
   the lifting means comprises a winch and/or a pulley;
   the system is adapted for assembling a wind turbine assembly or a jacket, such as an offshore wind turbine assembly or an offshore jacket assembly, e.g., for a wind turbine;
   the system comprises a clamping and/or gripping system comprising:
   the clamping device for gripping at least a portion of a wind turbine assembly; and
   a/the floating or buoyant body,
   the clamping device is mounted on the floating or buoyant body;
   the clamping device is configured for supporting at least a portion of a wind turbine assembly or jacket assembly in a vertical disposition and/or substantially upright configuration; and/or
   the clamping device is configured to engage with a flange or rim disposed on an outer surface of a/the portion of the structure.

1. A method of assembling an offshore wind turbine, such as a floating offshore wind turbine, the method comprising the steps of:
transporting, on one or more vessels, a nacelle and a tower of the offshore wind turbine to an assembly area below a support apparatus;
suspending the tower and the nacelle from the support apparatus;
transporting a floating/buoyant base or foundation body to the assembly area below the support apparatus; and
landing the tower on the floating/buoyant base or foundation body and the nacelle on the tower.

2. The method of claim 1, wherein the nacelle and the tower are transported to the assembly area together on a single vessel.

3. The method of claim 1, wherein:
the tower comprises a plurality of tower portions, and the tower is transported to the assembly area in a disassembled state; and
the method comprises a step of assembling the tower on the one or more vessels from the plurality of tower portions before the tower is suspended from the support apparatus.

4. The method of claim 3, comprising using a lifting arrangement of the support apparatus to stack the plurality of tower portions to assemble the tower.

5. The method of claim wherein the vessel comprises a seafastening grillage for supporting the plurality of tower portions, and optionally wherein the grillage is raised to allow access by personnel to an interior of each tower portion.

6. The method of claim 1, wherein suspending the nacelle from the support apparatus comprises using one or more lines or slings to suspend the nacelle in a holding position, and optionally wherein the holding position is offset from a vertical axis extending through an apex of the support apparatus.

7. The method of claim 6, wherein landing the nacelle on the tower comprises a step of cross-hauling the nacelle from the holding position to a landing position substantially below the apex of the support apparatus.

8. The method of claim 1, wherein the floating/buoyant base or foundation body comprises: a floater; floating spar; a tension-leg platform; a barge; or a semi-submersible platform.

9. The method of claim 1, comprising a step of stabilizing the floating/buoyant base or foundation body relative to a bed or floor of a body of water at the assembly area using a stabilising arrangement comprising at least one of: a jack; a mooring arrangement; an anchor arrangement; and/or a grounded vessel.

10. The method of claim 1, comprising a subsequent step of:
transporting, on the vessel, a plurality of blades of the offshore wind turbine to the assembly area; and
using a lifting arrangement of the support apparatus to lift each of the plurality of blades for coupling to the nacelle.

11. The method of claim 10, wherein the support apparatus comprises a cantilever portion extending from a leg and/or apex of the support apparatus, and wherein the method comprises lifting each of the plurality of blades by one or more lines extending from the cantilever portion.

12. The method of claim 1, wherein the support apparatus comprises an erectable tripod structure and a lifting arrangement and wherein, when the erectable tripod structure is erected, the assembly area is provided below the lifting arrangement.

13. A support apparatus for assembling an offshore wind turbine, such as a floating offshore wind turbine, the support apparatus comprising:
an erectable tripod structure;
a lifting arrangement for lifting a tower and/or a nacelle of the offshore wind turbine, the lifting arrangement provided above an assembly area when the tripod structure is erected; and
a support arrangement for suspending the tower and/or the nacelle from the erectable tripod structure.

14. The support apparatus of claim 13, wherein the support arrangement comprises one or more couplings or nodes on an apex member or leg of the erectable tripod structure for suspending the nacelle.

15. The support apparatus of claim 14, comprising one or more slings or lines for suspending the nacelle from the one or more couplings or nodes.

16. The support apparatus of any of claim 12, comprising a cantilever portion extending from the apex member or leg of the erectable tripod structure for suspending one or more blades of the offshore wind turbine.

17. The support apparatus of claim 12, wherein:
the erectable tripod structure is disposable in a first or collapsed state;
the erectable tripod structure is disposable in a second or expanded state;
the erectable tripod structure is expandable erectable or selectively movable from a/the first state to a/the second state;
the erectable tripod structure is collapsible or further selectively movable from a/the second state to a/the first state;
the erectable tripod structure is capable of being assembled and/or erected at site or in situ;
a plurality of legs of the erectable tripod structure are connected to or connectable to an/the apex member, and/or the lifting arrangement is, in use, provided below the apex member; and/or
each of the plurality of legs of the erectable tripod structure is attached at a first end to the apex member and/or each leg is provided at a second end with a mud mat, optionally the/each mud mat being selectively buoyant or submersible.
